(19) United States
(12) Patent Application Publication
(10) Pub. No.: US 2024/0267193 A1
(43) Pub. Date: Aug. 8, 2024

(54) TIMING FOR TWO-STAGE DOWNLINK CONTROL INFORMATION SCHEDULED UPLINK CHANNELS

(71) Applicant: QUALCOMM Incorporated, San Diego, CA (US)

(72) Inventors: Fang YUAN, Beijing (CN); Yu ZHANG, San Diego, CA (US); Chao WEI, Beijing (CN); Shaozhen GUO, Beijing (CN); Sony AKKARAKARAN, Poway, CA (US); Hao XU, Beijing (CN); Tao LUO, San Diego, CA (US); Xiaoxia ZHANG, San Diego, CA (US)

(21) Appl. No.: 18/564,533

(22) PCT Filed: Jul. 29, 2021
(86) PCT No.: PCT/CN2021/109150

§ 371 Date: Nov. 27, 2023

(51) Int. Cl. H04L 5/00; H04B 7/06; H04W 72/232

(52) U.S. Cl. CPC H04L 5/0092; H04B 7/06968; H04L 5/0048; H04W 72/232

(57) ABSTRACT

Methods, systems, and devices for wireless communications are described. A user equipment (UE) may receive, from a base station, a first downlink control information (DCI) message of a two-stage set of DCI. The UE may receive, from the base station, a second DCI message of the two-stage set of DCI. The UE may select between the first DCI message and the second DCI message as a timing reference point. In some examples, the UE may receive, from the base station, downlink data on the physical downlink channel. In some examples, the UE may transmit, to the base station, an uplink data message on the physical uplink channel.

### CROSS REFERENCE

The present Application is a 371 national stage filing of International PCT Application No. PCT/CN2021/109150 by YUAN et al. entitled “TIMING FOR TWO-STAGE DOWNLINK CONTROL INFORMATION SCHEDULED UPLINK CHANNELS,” filed Jul. 29, 2021, which is assigned to the assignee hereof, and which is expressly incorporated by reference in its entirety herein.

### FIELD OF TECHNOLOGY

The following relates to wireless communications, including timing for two-stage downlink control information (DCI) scheduled uplink channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE and a base station may schedule communications on physical uplink channels (e.g., physical uplink shared channels (PUSCHs)), physical downlink channels (e.g., physical downlink shared channel (PDSCHs)), or both, using two-phase downlink control information (DCI) signaling.

### SUMMARY

The described techniques relate to improved techniques, devices, and apparatuses that support techniques for timing for two-stage downlink control information (DCI) scheduled physical channels. In some examples, a user equipment (UE) and a base station) may communicate with each other on a physical uplink channel or a physical downlink channel according to scheduling information communicated via a two-stage DCI. The UE and the base station may schedule and perform such communications based on timelines which are measured from one of the DCIs. Such timelines may define beam selection for the UE, whether scheduled timelines satisfy threshold timing offsets (e.g., minimum scheduling offsets or processing times, or the like), etc. Techniques described herein define such rules and techniques for defining such timelines based on two-stage sets of DCIs.

A method for wireless communications at a UE is described. The method may include receiving, from a base station, a first DCI message of a two-stage set of DCI, receiving, from the base station, a second DCI message of the two-stage set of DCI, where the first DCI message and the second DCI message include scheduling information for downlink data message on a physical downlink channel, selecting between the first DCI message and the second DCI message as a timing reference point, and receiving, from the base station, the downlink data on the physical downlink channel based on a timing offset between the selected timing reference point and the scheduled downlink data.

An apparatus for wireless communications at a UE is described. The apparatus may include a processor, memory coupled with the processor, and instructions stored in the memory. The instructions may be executable by the processor to cause the apparatus to receive, from a base station, a first DCI message of a two-stage set of DCI, receive, from the base station, a second DCI message of the two-stage set of DCI, where the first DCI message and the second DCI message include scheduling information for downlink data message on a physical downlink channel, select between the first DCI message and the second DCI message as a timing reference point, and receive, from the base station, the downlink data on the physical downlink channel based on a timing offset between the selected timing reference point and the scheduled downlink data.

Another apparatus for wireless communications at a UE is described. The apparatus may include means for receiving, from a base station, a first DCI message of a two-stage set of DCI, means for receiving, from the base station, a second DCI message of the two-stage set of DCI, where the first DCI message and the second DCI message include scheduling information for downlink data message on a physical downlink channel, means for selecting between the first DCI message and the second DCI message as a timing reference point, and means for receiving, from the base station, the downlink data on the physical downlink channel based on a timing offset between the selected timing reference point and the scheduled downlink data.

A non-transitory computer-readable medium storing code for wireless communications at a UE is described. The code may include instructions executable by a processor to receive, from a base station, a first DCI message of a two-stage set of DCI, receive, from the base station, a second DCI message of the two-stage set of DCI, where the first DCI message and the second DCI message include scheduling information for downlink data message on a physical downlink channel, select between the first DCI message and the second DCI message as a timing reference point, and receive, from the base station, the downlink data on the physical downlink channel based on a timing offset between the selected timing reference point and the scheduled downlink data.

Some examples of the method, apparatuses, and non-transitory computer-readable medium described herein may further include operations, features, means, or instructions for receiving, from the base station, an indication of a time duration during which a quasi-co-location (QCL) relationship may be valid, the QCL relationship indicating that one or more antenna ports of the UE used to receive one or more reference signals may be quasi co-located with one or more antenna ports of the UE used to receive the downlink data, comparing the timing offset from the selected timing reference with the time duration, and selecting a receive beam on which to receive the downlink data message on the physical downlink channel based on the comparing.

Some examples of the method, apparatuses, and non-transitory computer-readable medium described herein may further include operations, features, means, or instructions for receiving, from the base station in the first DCI message or the second DCI message, a beam configuration indication including an indication of the receive beam and determining, based on the comparing, that the time duration may be less than the timing offset, where selecting the receive beam indicated by the beam configuration indication may be based on the determining, and where the receive beam may be not associated with the QCL relationship.

Some examples of the method, apparatuses, and non-transitory computer-readable medium described herein may further include operations, features, means, or instructions for determining, based on the comparing, that the time duration may be greater than the timing offset, where the receive beam includes a default receive beam associated with the one or more reference signals according to the QCL relationship.

In some examples of the method, apparatuses, and non-transitory computer-readable medium described herein, the selecting may include operations, features, means, or instructions for selecting the first DCI message as the timing reference point, where the timing offset includes a time period between a last transmission time interval (TTI) boundary of the first DCI message and a first TTI boundary of the downlink data message.

In some examples of the method, apparatuses, and non-transitory computer-readable medium described herein, receiving the first DCI message may include operations, features, means, or instructions for receiving a beam configuration indication in the first DCI message, where selecting the first DCI message as the timing reference point may be based on receiving the beam configuration indication in the first DCI message.

In some examples of the method, apparatuses, and non-transitory computer-readable medium described herein, the selecting may include operations, features, means, or instructions for selecting the second DCI message as the timing reference point, and where the timing offset includes a time period between a last TTI boundary of the first DCI message and a first TTI boundary of the downlink data message.

In some examples of the method, apparatuses, and non-transitory computer-readable medium described herein, receiving the second DCI message may include operations, features, means, or instructions for receiving a beam configuration indication in the second DCI message, where selecting the second DCI message as the timing reference point may be based on receiving the beam configuration indication in the first DCI message.

In some examples of the method, apparatuses, and non-transitory computer-readable medium described herein, the communicating may include operations, features, means, or instructions for receiving the downlink data message on the physical downlink channel based on the timing offset from the selected timing reference point satisfying a threshold offset value.

In some examples of the method, apparatuses, and non-transitory computer-readable medium described herein, the selecting may include operations, features, means, or instructions for selecting the first DCI message as the timing reference point, where the timing offset includes a time period between a last TTI boundary of the first DCI message and a first TTI boundary of the downlink data message.

In some examples of the method, apparatuses, and non-transitory computer-readable medium described herein, receiving the first DCI message may include operations, features, means, or instructions for receiving, in the first DCI message, an indication of a starting point and a length of the downlink data message, where selecting the first DCI message as the timing reference point may be based on receiving the indication of the starting point and the length in the first DCI message.

Some examples of the method, apparatuses, and non-transitory computer-readable medium described herein may further include operations, features, means, or instructions for selecting the second DCI message as the timing reference point, where the timing offset includes a time period between a last TTI boundary of the second DCI message and a first TTI boundary of the downlink data message.

Some examples of the method, apparatuses, and non-transitory computer-readable medium described herein may further include operations, features, means, or instructions for receiving, in the second DCI message, an indication of a starting point and a length of the downlink data message, where selecting the second DCI message as the timing reference point may be based on receiving the indication of the starting point and the length in the second DCI message.

Some examples of the method, apparatuses, and non-transitory computer-readable medium described herein may further include operations, features, means, or instructions for receiving, from the base station, a third DCI message of a second two-stage set of DCI, receiving, from the base station, a fourth DCI message of the second two-stage set of DCI, where the third DCI message and the fourth DCI message include scheduling information for a second downlink data message on a physical downlink channel, selecting both the first DCI message and the second DCI message as a second timing reference point, where a second timing offset includes a first time period between a last TTI boundary of the third DCI message and a first TTI boundary of the second downlink data message, and a second time period between a last TTI boundary of the fourth DCI message and the first TTI boundary of the second downlink data message, and receiving the second downlink data message on the physical downlink channel based on both the first time period and the second time period satisfying a threshold offset value.

A method for wireless communications at a UE is described. The method may include receiving, from a base station, a first DCI message of a two-stage set of DCI, receiving, from the base station, a second DCI message of the two-stage set of DCI, where the first DCI message and the second DCI message include scheduling information for uplink data message on a physical uplink channel, selecting between the first DCI message and the second DCI message as a timing reference point based on a location of an indication of a starting point and a length of the uplink data message, and transmitting, to the base station, the uplink data message on the physical uplink channel based on a timing offset between the selected timing reference point and the scheduled uplink data message satisfying a threshold offset value.

An apparatus for wireless communications at a UE is described. The apparatus may include a processor, memory coupled with the processor, and instructions stored in the memory. The instructions may be executable by the processor to cause the apparatus to receive, from a base station, a first DCI message of a two-stage set of DCI, receive, from the base station, a second DCI message of the two-stage set of DCI, where the first DCI message and the second DCI message include scheduling information for uplink data message on a physical uplink channel, select between the first DCI message and the second DCI message as a timing reference point based on a location of an indication of a starting point and a length of the uplink data message, and transmit, to the base station, the uplink data message on the physical uplink channel based on a timing offset between the selected timing reference point and the scheduled uplink data message satisfying a threshold offset value.

Another apparatus for wireless communications at a UE is described. The apparatus may include means for receiving, from a base station, a first DCI message of a two-stage set of DCI, means for receiving, from the base station, a second DCI message of the two-stage set of DCI, where the first DCI message and the second DCI message include scheduling information for uplink data message on a physical uplink channel, means for selecting between the first DCI message and the second DCI message as a timing reference point based on a location of an indication of a starting point and a length of the uplink data message, and means for transmitting, to the base station, the uplink data message on the physical uplink channel based on a timing offset between the selected timing reference point and the scheduled uplink data message satisfying a threshold offset value.

A non-transitory computer-readable medium storing code for wireless communications at a UE is described. The code may include instructions executable by a processor to receive, from a base station, a first DCI message of a two-stage set of DCI, receive, from the base station, a second DCI message of the two-stage set of DCI, where the first DCI message and the second DCI message include scheduling information for uplink data message on a physical uplink channel, select between the first DCI message and the second DCI message as a timing reference point based on a location of an indication of a starting point and a length of the uplink data message, and transmit, to the base station, the uplink data message on the physical uplink channel based on a timing offset between the selected timing reference point and the scheduled uplink data message satisfying a threshold offset value.

Some examples of the method, apparatuses, and non-transitory computer-readable medium described herein may further include operations, features, means, or instructions for receiving, in the first DCI message, the indication of the starting point and the length of the uplink data message, where selecting the timing reference point includes selecting the first DCI message, and where the timing offset includes a time period between a last TTI boundary of the first DCI message and a first TTI boundary of the uplink data message.

Some examples of the method, apparatuses, and non-transitory computer-readable medium described herein may further include operations, features, means, or instructions for receiving, in the second DCI message, the indication of the starting point and the length of the uplink data message, where selecting the timing reference point includes selecting the second DCI message, and where the timing offset includes a time period between a last TTI boundary of the second DCI message and a first TTI boundary of the uplink data message.

In some examples of the method, apparatuses, and non-transitory computer-readable medium described herein, the threshold offset value includes a time duration between a last symbol of the selected timing reference point and a next symbol having a cyclic prefix that begins after the last symbol of the selected timing reference point.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports timing for two-stage downlink control information (DCI) scheduled uplink channels in accordance with aspects of the present disclosure.

FIG. 2 illustrates an example of a wireless communications system that supports timing for two-stage DCI scheduled uplink channels in accordance with aspects of the present disclosure.

FIG. 3 illustrates an example of timelines that support timing for two-stage DCI scheduled uplink channels in accordance with aspects of the present disclosure.

FIG. 4 illustrates an example of timelines that support timing for two-stage DCI scheduled uplink channels in accordance with aspects of the present disclosure.

FIG. 5 illustrates an example of timelines that support timing for two-stage DCI scheduled uplink channels in accordance with aspects of the present disclosure.

FIG. 6 illustrates an example of a process flow that supports timing for two-stage DCI scheduled uplink channels in accordance with aspects of the present disclosure.

FIG. 7 illustrates an example of a process flow that supports timing for two-stage DCI scheduled uplink channels in accordance with aspects of the present disclosure.

FIG. 8 illustrates an example of a process flow that supports timing for two-stage DCI scheduled uplink channels in accordance with aspects of the present disclosure.

FIGS. 9 and 10 show block diagrams of devices that support timing for two-stage DCI scheduled uplink channels in accordance with aspects of the present disclosure.

FIG. 11 shows a block diagram of a communications manager that supports timing for two-stage DCI scheduled uplink channels in accordance with aspects of the present disclosure.

FIG. 12 shows a diagram of a system including a device that supports timing for two-stage DCI scheduled uplink channels in accordance with aspects of the present disclosure.

FIGS. 13 through 16 show flowcharts illustrating methods that support timing for two-stage DCI scheduled uplink channels in accordance with aspects of the present disclosure.

### DETAILED DESCRIPTION

In some wireless communications systems, a user equipment (UE) and a base station may schedule communications on physical uplink channels (e.g., physical uplink shared channels (PUSCHs)), physical downlink channels (e.g., physical downlink shared channel (PDSCHs)), or both. A base station may transmit, to a UE, a downlink control information (DCI) message including scheduling information for an uplink data transmission or a downlink data transmission. In such examples, the wireless communications system may support two-stage DCI signaling. In such examples, the base station may transmit two DCI messages to the UE (e.g., the first DCI may include partial scheduling information, an indication of resources for the second DCI, or the like, and the second DCI may include partial or complete scheduling information for the physical channel). In some examples, one or more timelines for scheduling and performing communications may be defined with reference to a DCI. For example, wireless devices may determine whether to use default beams or updated beams indicated in a received DCI for receiving transmission over a physical downlink shared channel (PDSCH). In some examples, downlink data message may be scheduled such that the downlink messages satisfy a minimum timing offset restriction (which may be measured from a DCI). In some examples, the UE may transmit uplink signaling if uplink transmissions on a physical uplink shared channel (PUSCH) are scheduled after a threshold processing time, which may be measured from the DCI. However, a UE that receives scheduling information via two-stage DCI signaling may rely on timelines measured from one or both of the two DCIs to successfully perform scheduled wireless communications. It may therefore be beneficial to define whether such wireless communications timelines are defined from a first DCI of a two-stage set of DCIs, a second DCI of a two-stage set of DCIs, or both.

In some examples, a UE may determine whether to use a default receive beam or a receive beam indicated in a DCI for receiving transmissions over a scheduled PDSCH based on an offset between a DCI message (e.g., the first or second DCI message in the two-stage DCI procedure) and the scheduled PDSCH. For example, the UE may be configured with a threshold time duration during which a quasi co-location (QCL) relationship is valid. The QCL relationship may indicate that a set of one or more antenna ports for receiving downlink reference signals can be used for receiving one or more additional signals (e.g., a scheduled downlink data transmission). If the offset from a selected DCI message (e.g., of the two-stage DCI) to the PDSCH is less than the threshold time duration, then the UE may use a default receive beam indicated by the QCL relationship to receive the scheduled downlink transmissions. If the offset from the selected DCI message is greater than the threshold time duration, the UE may use a receive beam indicated in the DCI (e.g., via a transmission configuration indicator (TCI) state included in the DCI). The offset may be determined from the first DCI, or the second DCI, as specified in one or more standards. Or, the offset may be determined from whichever of the first or second DCI includes an indication of the TCI state.

In some other examples, the base station may schedule the UE to receive downlink transmissions on the PDSCH if the PDSCH is scheduled such that the offset from a selected DCI (e.g., the first DCI or the second DCI of the two-stage DCI) satisfies a threshold offset value (e.g., a minimum K value defining an amount of time or number of symbols between the DCI and the scheduled downlink transmission). The offset (to be compared with the threshold offset value) may be defined with reference to the first DCI or the second DCI, as specified in one or more rules. The offset may be defined with reference to whichever of the first or second DCI that includes a start and length indicator value (SLIV). The PDSCH may be scheduled to satisfy the threshold offset value for both the first DCI and the second DCI.

In some other examples, the base station may schedule uplink transmissions on a PUSCH if an offset from one of the DCIs (e.g., the first or second DCI of the two-stage DCI) satisfies a threshold offset value (e.g., a processing time defined by a first available uplink symbol satisfying one or more criteria). The offset may be defined with reference to whichever of the two DCIs includes an SLIV.

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to timing for two-stage DCI scheduled uplink channels.

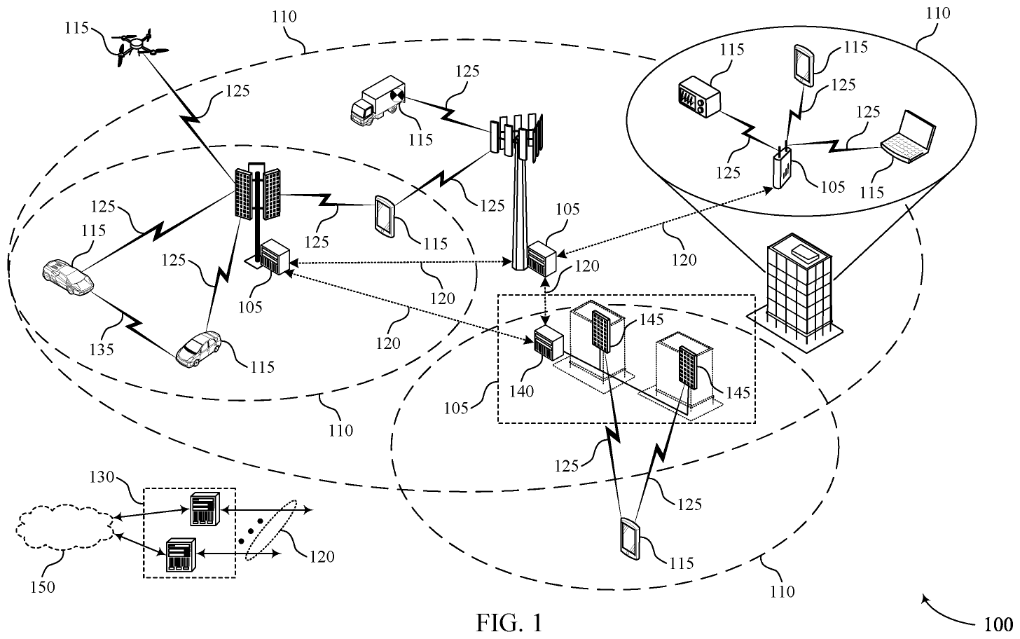

FIG. 1 illustrates an example of a wireless communications system 100 that supports timing for two-stage DCI scheduled uplink channels in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

According to the techniques described herein, in some examples, a UE 115 may determine whether to use a default receive beam or a receive beam indicated in a DCI for receiving transmissions over a scheduled PDSCH based at least in part on an offset between a DCI message (e.g., the first or second DCI message in the two-stage DCI procedure) and the scheduled PDSCH. The offset may be determined from the first DCI, or the second DCI, as specified in one or more standards. Or, the offset may be determined from whichever of the first or second DCI includes an indication of a TCI state.

In some other examples, a base station 105 may schedule the UE 115 to receive downlink transmissions on the PDSCH if the PDSCH is scheduled such that the offset from a selected DCI (e.g., the first DCI or the second DCI of the two-stage DCI) satisfies a threshold offset value (e.g., a minimum K value defining an amount of time or number of symbols between the DCI and the scheduled downlink transmission or the PDSCH on which the downlink transmission is scheduled). The offset (to be compared with the threshold offset value) may be defined with reference to the first DCI or the second DCI, as specified in the standards. The offset may be defined with reference to whichever of the first or second DCI that includes an SLIV. The PDSCH may be scheduled to satisfy the threshold offset value for both the first DCI and the second DCI.

In some other examples, the base station 105 may schedule uplink transmissions on a PUSCH if an offset from one of the DCIs (e.g., the first or second DCI of the two-stage DCI) satisfies a threshold offset value (e.g., a processing time defined by a first available uplink symbol satisfying one or more criteria). The offset may be defined with reference to whichever of the two DCIs includes an SLIV.

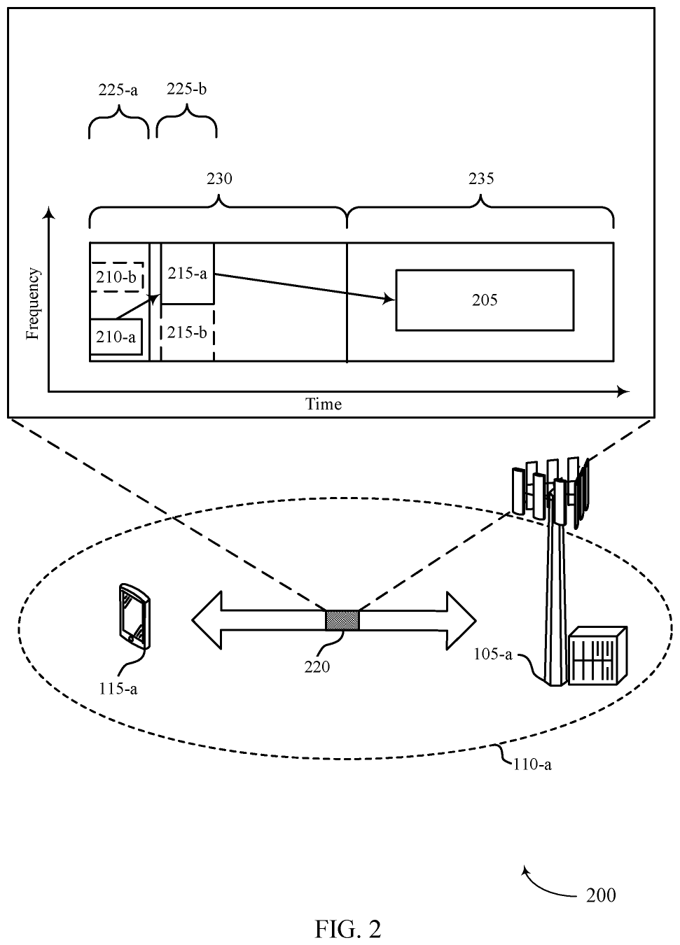

FIG. 2 illustrates an example of a wireless communications system 200 that

supports timing for two-stage DCI scheduled physical channels in accordance with various aspects of the present disclosure. In some examples, wireless communications system 200 may include aspects of wireless communications system 100. For example, wireless communications system 200 may include a base station 105-a and a UE 115-a, which may be examples of a base station 105 and a UE 115 as described with reference to FIG. 1.

Wireless communications system 200 may support wireless communications between one or more UEs 115-a and base stations 105-a via time and frequency resources 220. For example, base station 105-a may schedule data transmissions on a physical channel (e.g., downlink data messages on a PDSCH, uplink data messages on a PUSCH, or both). In some examples, base station 105-a may schedule data transmissions on the physical channel 205 via two-stage DCI signaling. For instance, base station 105-a may transmit, to UE 115-a, a first DCI message 210 and a second DCI message 215 during a first slot 230, scheduling uplink or downlink data signaling on the physical channel 205 during second slot 235.a first DCI message 210 and a second DCI message 215 (e.g., the two-stage set of DCI). The first DCI message 210 may be located within a control resource set (CORESET) 225-a (e.g., first DCI message 210-b, or first DCI message 210-a within CORESET 225-a). Similarly, second DCI message 215 may occupy different frequency resources within a second CORESET 225-b (e.g., second DCI message 215-a or second DCI message 215-b). Depending on the configuration of first CORESET 225-a and second CORESET 225-b, DCI messages may span some or all time resources of a CORESET 225, and some or all frequency resources on the CORESET. For instance, CORESET 225-a may span three symbols in the time domain, but first DCI message 210-a may span two of the three symbols of CORESET 225-a. However, second DCI message 215-a may span all three symbols of CORESET 225-b. Or, in some illustrative examples, CORESET 225-a may be a two symbol CORESET, and first DCI message 210-a may span both symbols of CORESET 225-a. Thus, although illustrated with reference to FIG. 2 such that first DCI message 210-a spans a portion of the time resources of first CORESET 225-a and second DCI message 215-a spans the entirety of the time resources of second CORESET 225-b, any first DCI message 210, or any second DCI message 215 described herein may span a portion or an entirety of the time or frequency resources of a corresponding CORESET 225.

A first DCI message 210 and a second DCI message 215 may schedule data messages on the physical channel 205. For example, first DCI message 210-a may include an indication of time resources, frequency resources, spatial resources, or any combination thereof, for second DCI message 215-a. Second DCI message 215-a may include an allocation of resources for a data message on the physical channel 205. In some examples, a first DCI message 210 may include common DCI for multiple UEs 115 (e.g., including UE 115-a), and second DCI message 215 may include UE-specific DCI for UE 115-a. UE 115-a may monitor a search space within CORESET 225-a to receive first DCI message 210-a (e.g., which may include an indication of a location of second DCI message 215-a), and UE 115-a may monitor indicated resources within second CORESET 225-b (e.g., as indicated in first DCI message 210-a) to receive second DCI message 215-a. Based on a grant of resources included in second DCI message 215-a, UE 115-a may receive or transmit a data message on the physical channel 205.

UE 115-a and base station 105-a may communicate on the physical channel 205 according to one or more timelines. For example, UE 115-a may select a receive beam on which to receive downlink data messages on the physical channel 205 (e.g., a PDSCH) according to a timing offset between receiving a DCI message and the scheduled PDSCH. In some examples, uplink or downlink signaling may be scheduled to satisfy a threshold offset value or a threshold processing time, or the like. Such a timeline may be defined in the context of single-DCI scheduled physical channels. However, the offset may be able to be defined with respect to the first DCI message 210, the second DCI message 215, or both. If UEs 115-a or base stations 105-a or both do not determine such timelines (e.g., with some amount of reliability), then some wireless communications may fail, UE 115-a may attempt to receive downlink transmissions using an incorrect or outdated beam, base station 105-a may schedule uplink or downlink transmissions that UE 115-a is incapable of receiving or transmitting, or the like. Such failures may result in increased retransmissions, decreased system latency, decreased user experience, or the like.

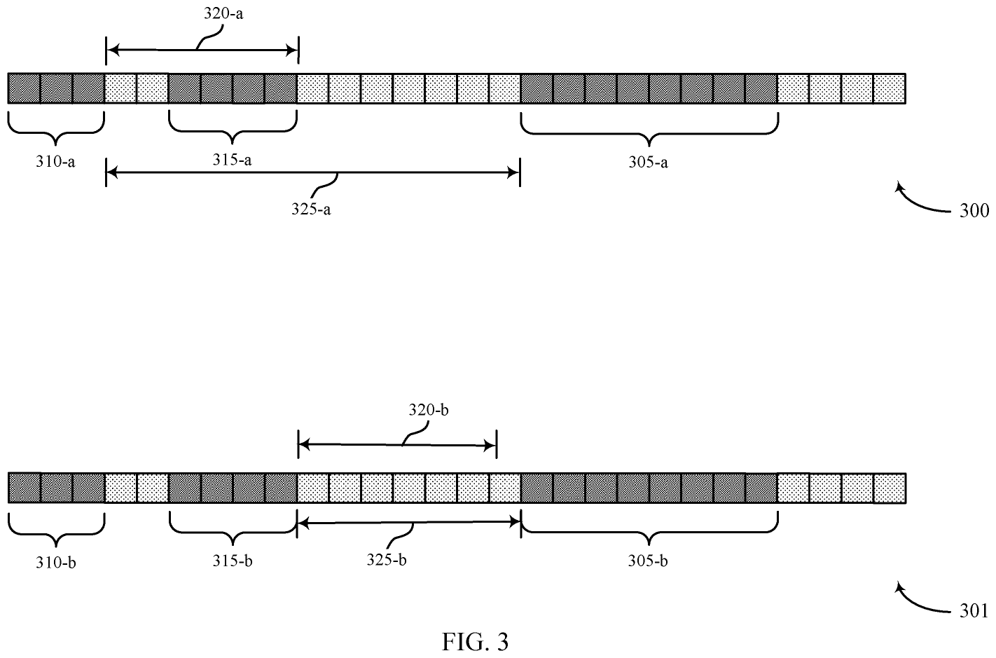

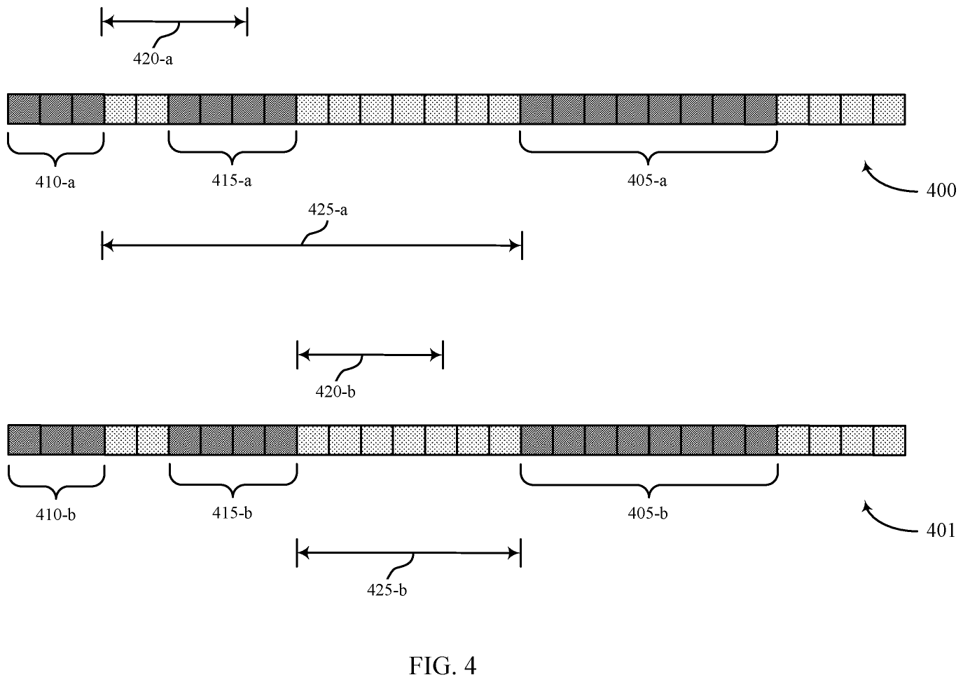

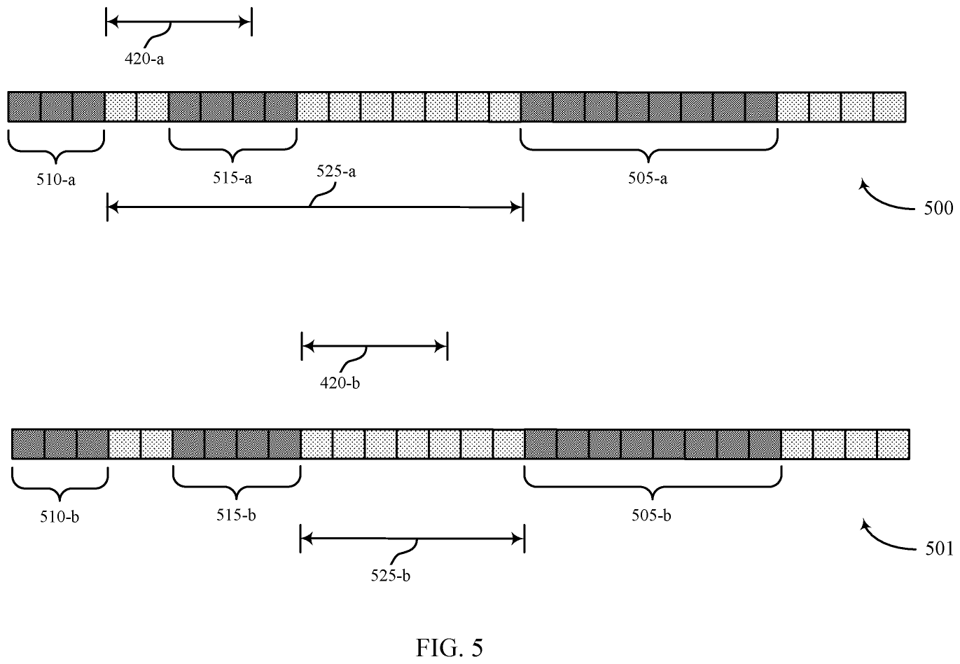

As described herein, UE 115-a, base station 105-a, or both, may determine (e.g., select) a first DCI message 210 or a second DCI message 215 as a reference point from which one or more timing offsets can be defined. For example, UE 115-a and base station 105-a may define an offset between a selected reference point DCI message (e.g., first DCI message 210-a or second DCI message 215-a) and the data message scheduled on the physical channel 205). In some examples, as described in greater detail with reference to FIG. 3, UE 115-a may determine whether the measured offset is greater than or less than a threshold time period (e.g., a time duration during which a QCL relationship is valid) to determine a receive beam on which to receive a downlink data message scheduled by the two-stage DCI. In some examples, as described in greater detail with reference to FIG. 4, base station 105-a may schedule downlink data messages on the physical channel 205 if the offset from the selected reference point DCI satisfies a threshold offset value (e.g., UE 115-a may be expected to receive downlink data messages if such a threshold offset value is satisfied). In some example, as described in greater with reference to FIG. 5, base station 105-a may schedule uplink data messages on the physical channel 205 if the offset from the selected reference point DCI satisfies a threshold offset value (e.g., UE 115-a may be expected to transmit downlink data messages after a processing time, which is defined form the selected reference point DCI). In some examples, as described with reference to FIGS. 3-6, the reference point DCI may be the first DCI message 210, the second DCI message 215, or both, based on one or more rules or standards, based on the contents of the DCI messages, or any combination thereof.

FIG. 3 illustrates an example of timelines 300 and 301 that support timing for two-stage DCI scheduled physical channels in accordance with various aspects of the present disclosure. The timelines 300 and 301 may span one or more TTIs (e.g., symbols), as illustrated. In some examples, timelines 300 may be included in aspects of wireless communications system 100, wireless communications system 200, or both. For example, base station 105-a and UE 115-a may communicate with each other according to one or more of timelines 300 or 301.

In some examples, a base station 105 (e.g., base station 105-a, as described with reference to FIG. 2) may schedule a downlink data message on a physical channel (e.g., PDSCH 305). A UE (e.g., UE 115-a as described with reference to FIG. 2) may determine whether UE 115-a is to use a default beam or a different beam for receiving the downlink message on PDSCH 305 based on a timing offset from a DCI message to PDSCH 305. Base station 105-a may schedule the downlink data message via a two-stage DCI. For example, base station 105-a may transmit a first DCI message 310-a, and a second DCI message 315-a. For instance, one or more parameters may be enabled (e.g., tci-PresentInDCI may be enabled), or the variable (e.g., tci-PresentInDCI) may not be configured in a radio resource control (RRC) connected mode. In such examples, a DCI message may include an indication of a TCI state (e.g., an indication of a receive beam).

In some examples, base station 105-a may configure UE 115-a with one or more QCL relationships. A QCL relationship may indicate that one or more antenna ports (e.g., demodulation reference signal (DRMS) ports) of PDSCH 305 of a serving cell (e.g., associated with base station 105-a) are QCL with reference signals received in a PDSCH. That is, if such a QCL relationship is established, UE 115-a may assume that the demodulation reference signal (DMRS) ports of the serving cell are QCL with the reference signals with respect to the QCL parameters used for a PDCCH QCL indication of a CORESET associated with a monitored search space with the lowest CORESET-ID in the latest slot in which one or more CORESETS within an active BWP of a serving cell are monitored by UE 115-a. In some examples, such a QCL relationship may be valid for an amount of time (e.g., the antenna ports associated with the reference signals are QCL with one or more antenna ports associated with one or more additional signals, such as the scheduled downlink data message). For instance, the QCL relationship may be valid for a time duration (e.g., timeDurationForQCL 320).

As described in greater detail with reference to FIG. 2, base station 105-a may transmit a first DCI message 310 (e.g., including an indication of a second DCI message 315) and a second DCI message 315 (e.g., including a grant of resources for a downlink message on PDSCH 305-a). In some examples, the first DCI message 310, second DCI message 315, or both, may span some or all of a CORESET. Although FIG. 3 illustrates each DCI as spanning the entire CORESET, some examples may include the first DCI message 310 spanning any number of symbols, up to the full number of symbols spanned by the corresponding CORESET. The offset may thus be measured as described herein (e.g., with reference to any of FIGS. 1-6) with reference to either of the DCI message itself (e.g., a final symbol boundary of the DCI message, even in the case where the final symbol boundary of the DCI message occurs prior to the final symbol boundary of the CORESET), or the final symbol boundary of the corresponding CORESET (e.g., which may or may not align in time with the final symbol boundary of the DCI message).

In some examples, UE 115-a may determine whether to use a default receive beam (e.g., associated with the QCL relationship) or a new, updated, or activated receive beam (e.g., indicated by the TCI state in the DCI) based on whether a timing offset from a received DCI is greater than or less than the time duration (e.g., time DurationForQCL 320). However, such a determination may vary based on which DCI of a two-stage DCI UE 115-a uses as a reference point.

In some examples, as illustrated with reference to timeline 300, UE 115-a may determine which receive beam to use based on an offset 325-a between the reception of the first DCI message 310-a and the scheduled PDSCH 305-a. If offset 325-a is less than a time duration (e.g., timeDurationForQCL 320-a), then UE 115-a (e.g., or base station 105-a, or both) may assume that the DMRS ports of PDSCH of a serving cell are quasi co-located with one or more RSs with respect to one or more QCL parameters. The QCL parameters may be used for a PDCCH QCL indication of the CORESET associated with a monitored search space with a lowest value or variable (e.g., CORESET-ID)) in a latest slot in which one or more CORESETs within an active bandwidth part (BWP) of the serving cell are monitored by UE 115-a. Thus, if the offset 325-a between the reception of the first DCI message 310-a and the scheduled PDSCH 305-a is less than time DurationForQCL 320-a, then UE 115-a may determine to use the default beam for PDSCH reception. During timeDurationForQCL 320-a, a QCL relationship may be valid. In such examples, UE 115-a may receive PDSCH 305-a using the default receive beam (e.g., according to the QCL relationship). However, if the offset 325-a from the first DCI message 310-a is greater than time DurationForQCL 320-a, the UE 115-a may use a receive beam indicated in the first DCI message 310-a (e.g., via a TCI state included in the first DCI message 310-a). In some examples, the offset 325-amay be defined with reference to the first DCI message 310-a (e.g., instead of the second DCI message 315-a) based on one or more rules, which may be included in one or more standard documents, preconfigured at UE 115-a, indicated by base station 105-a, or any combination thereof.

In some other examples, as illustrated with reference to timeline 301, the offset 325-b may be defined with reference to second DCI message 315-b. For example, if the offset 325-b between the reception of the second DCI message 315-b and the scheduled PDSCH 305-b is less than the time duration (e.g., timeDurationForQCL. 320-b) during which the QCL relationship is valid, then UE 115-a (e.g., or base station 105-a, or both) may assume that the DMRS ports of PDSCH of a serving cell are quasi co-located with one or more RSs with respect to one or more QCL parameters. The QCL parameters may be used for a physical downlink control channel (PDCCH) QCL indication of the CORESET associated with a monitored search space with a lowest value or variable (e.g., (CORESET-ID)) in a latest slot in which one or more CORESETs within an active BWP of the serving cell are monitored by UE 115-a. That is, if the offset 325-b between the reception of the second DCI message 315-b and the scheduled PDSCH 305-b is less than timeDurationForQCL 320-b, then UE 115-a may determine to use the default beam (e.g., the receive beam on which one or more reference signals are received according to the QCL relationship) for PDSCH reception. During time DurationForQCL 320, the QCL relationship may be valid. However, if the offset 325-b from the second DCI message 315-b is greater than timeDurationForQCL 320-b, then UE 115-a may use a receive beam indicated in the DCI (e.g., via a TCI state included in the first DCI message 310-b or the second DCI message 315-b). In some examples, the offset 325-b may be defined with reference to the second DCI message 315-b (e.g., instead of the first DCI message 310-b) based on one or more rules, which may be included in one or more standard documents, preconfigured at UE 115-a, indicated by base station 105-a, or any combination thereof.

In some examples, the offset 325 may be defined with reference to either the first DCI message 310 or the second DCI message 315, based on which of the two DCI messages includes the indication of the TCI state. For example, if the offset between the reception of the PDCCH (e.g., the DCI message) carrying the TCI indication (e.g., offset 325-a if the TCI field is present in the first DCI message 310, offset 325-b if the TCI field is present in the second DCI message 315) for the scheduled PDSCH is less than the threshold variable (e.g., timeDurationForQCL 320), then UE 115-a (e.g., or base station 105-a) may assume that the DMRS ports of PDSCH of a serving cell are quasi co-located with one or more RSs with respect to one or more QCL parameters. The QCL parameters may be used for a PDCCH QCL indication of the CORESET associated with a monitored search space with a lowest value or variable (e.g., (CORESET-II)) in a latest slot in which one or more CORESETs within an active BWP of the serving cell are monitored by UE 115-a. For instance, first DCI message 310-a may include the TCI state field. In such examples, if the offset 325-a between the first DCI message 310-a carrying the TCI state indication and the scheduled PDSCH 305-a is less than timeDurationForQCL 320-a, then UE 115-a may determine to use the default beam for receiving the downlink message on PDSCH 305-a. However, if the offset 325-a between the reception of the first DCI message 310-a carrying the TCI state indication is greater than timeDurationForQCL 320-a, then UE 115-a may use a receive beam indicated in the TCI indication received in the first DCI message 310-a. In some examples, second DCI message 315-b may include the TCI state field. In such examples, if the offset 325-b between the second DCI message 315-b carrying the TCI state indication and the scheduled PDSCH 305-b is less than timeDurationForQCL 320-b, then UE 115-a may determine to use the default beam for receiving the downlink message on PDSCH 305-b. However, if the offset 325-b between the reception of the second DCI message 315-b carrying the TCI state indication is greater than timeDurationForQCL. 320-b, then UE 115-a may use a receive beam indicated in the TCI indication received in the second DCI message 315-b.

In some examples, as described in greater detail with reference to FIG. 4, base station 105-a may schedule UE 115-a with downlink data messages such that an offset 325 may be defined with reference to a first DCI message 310 or a second DCI message 315, or both.

FIG. 4 illustrates an example of timelines 400 and 401 that support timing for two-stage DCI scheduled physical channels in accordance with various aspects of the present disclosure. The timelines 400 and 401 may span one or more symbols, as illustrated. In some examples, a UE 115-a and a UE 115-b may implement timelines 400 and 401. In some examples, as illustrated with reference to FIG. 4, wireless devices may implement a single timeline constraint for communications on a PDSCH 405.

In some examples, as described in greater detail with reference to FIGS. 2-3, a base station 105-a may schedule downlink messages on a PDSCH 405-a via two-stage DCI signaling (e.g., via first DCI message 410 and second DCI message 415). Base station 105-a may schedule the downlink messages in accordance with a threshold offset value, which may be referred to as a minimum scheduling offset restriction. For instance, base station 105-a may schedule the downlink message on PDSCH 405 at a timing offset (e.g., which may be referred to as K₀) from one of the DCI messages to the scheduled downlink message on PDSCH 405. The timing offset may be defined as an absolute value of time, as a number of TTIs (e.g., slots, symbols, etc.), or the like. The threshold offset value (e.g., which may be referred to as K₀ₘᵢₙ) may defined as a minimum or threshold value for the timing offset. Thus, if the threshold offset value (e.g., the minimum scheduling offset restriction) is applied, UE 115-a may not be expected to be scheduled with a two-stage DCI to receive a PDSCH scheduled with a temporary identifier (e.g., a cellular radio network temporary identifier (C-RNTI), a configured scheduling RNTI (CS-RNTI), a modulation and coding scheme cellular RNTI (MCS-C-RNTI), or the like) with a K₀ smaller than the applicable minimum scheduling offset restriction K₀ₘᵢₙ. Thus, base station 105-a may refrain from scheduling downlink messages on PDSCH 405 if the offset 425 is not greater than the threshold offset value 420. In some examples, if base station 105-a does schedule a downlink message on PDSCH 405 such that the offset 425 is smaller than the threshold offset value 420, UE 115 may not be expected to (e.g., may refrain from) receiving the downlink message on PDSCH 405. Offset 425 (to be compared to the threshold offset value 420) may be defined relative to a DCI message (e.g., first DCI message 410, second DCI message 415, or both). In some examples, offset 425-a may be defined as a time offset from the end of the first DCI message 410-a of the two-stage DCI to the start of the scheduled PDSCH 405-a. In such examples, base station 105-a may schedule PDSCH 405-a such that offset 425-a is greater than threshold offset value 420-a. In some examples, UE 115-a may determine that offset 425-a is greater than threshold offset value 420-a, and may receive the downlink message on PDSCH 405-b based at least in part on the determining. The offset 425-a may be defined with reference to the first DCI message 410-a based on one or more rules, which may be defined in one or more standards documents, preconfigured at UE 115-a, indicated by base station 105-a, or any combination thereof.

In some examples, offset 425-b may be defined as a time offset from the end of the second DCI message 415-b of the two-stage DCI to the start of the scheduled PDSCH 405-b. In such examples, base station 105-a may schedule PDSCH 405-b such that offset 425-b is greater than threshold offset value 420-b. In some examples, UE 115-a may determine that offset 425-b is greater than threshold offset value 420-b, and may receive the downlink message on PDSCH 405-b based at least in part on the determining. The offset 425-b may be defined with reference to the second DCI message 415-b based on one or more rules, which may be defined in one or more standards documents, preconfigured at UE 115-a, indicated by base station 105-a, or any combination thereof.

In some examples, offset 425 may be defined with respect to the first DCI message 410 or the second DCI message 415 depending on whether an indication of a starting point and length of the downlink message on the PDSCH 405 is present in the first DCI message 410 or the second DCI message 415. For instance, offset 425-a may be defined with reference to first DCI message 410-a if a SLIV for PDSCH 405-a is included in the first DCI message 410-a. Or, offset 425-b may be defined with reference to second DCI message 415-b if the SLIV for PDSCH 405-b is included in the second DCI message 415-b. In some examples, UE 115-a (e.g., or base station 105-a, or both) may determine which of first DCI message 410 and second DCI message 415 is the reference point for defining offset 425 based at least in part on the location of the SLIV based on one or more rules, which may be included in one or more standards documents. In some examples, criteria for selecting which DCI message is to be considered the reference point for offset 425 may be preconfigured at UE 115-a, indicated by base station 105-a, or any combination thereof.

In some examples, offset 425 may be defined with reference to both DCI messages of a two-stage DCI. For example, offset 425 may be a time offset from the end of the first DCI message 410 to the start of the scheduled PDSCH 405 and the time offset from the end of the second DCI message 415 to the start of the scheduled PDSCH 405. In some examples, base station 105-a may schedule PDSCH 405 such that both offset 425-a from first DCI message 410 and offset 425-b from second DCI message 415 satisfy threshold offset value 420 (e.g., base station 105-a, UE 115-a, or both, may compare both offset 425-a and offset 425-b to a single threshold offset value 420). In some examples, the offset (e.g., K₀) may be defined as the sum of offset 425-a and offset 425-b, which may be compared (e.g., by UE 115-a or base station 105-a) to K₀. Defining the offset with reference to both first DCI message 410 and second DCI message 415 may be based at least in part on one or more rules, which may be included in one or more standards documents, preconfigured at UE 115-a, indicated by base station 105-a, or any combination thereof.

In some examples, a timeline for uplink signaling may be defined with reference to a first DCI message 410 or a second DCI message 415, as described in greater detail with reference to FIG. 5.

FIG. 5 illustrates an example of a timelines 500 and 501 that support timing for two-stage DCI scheduled physical channels in accordance with various aspects of the present disclosure. The timelines 500 and 501 may span one or more symbols, as illustrated. In some examples, a UE 115-a and a base station 105-a (e.g., as illustrated and described with reference to FIGS. 1-4) may communicate according to timelines 500 and 501.

In some examples, as described with reference to FIG. 2, base station 105-a may schedule an uplink data message on a physical channel (PUSCH 505). In some examples, base station 105-a may schedule the uplink data message such that an offset 525 between a DCI message (e.g., the first DCI message 510 or the second DCI message 515 of a two-stage DCI) satisfies a threshold offset value (e.g., which may be referred to as a processing time (T_{proc2}). For instance, UE 115-a may transmit a transport block (e.g., of the data message on PUSCH 505) if the first uplink symbol in the PUSCH 505 allocation for a transport block, including the DMRS, as defined by the slot offset K2 (e.g., a number of slots between the scheduling information received in the DCI and the PUSCH 505) and the SLIV of the SLIV of the scheduling two-stage DCI and including the effect of the timing advance, starts no earlier than at symbol L2. Symbol L2 may be defined as a next uplink symbol with a cyclic prefix (CP) starting after the end of the reception of the last symbol of the PDCCH carrying the SLIV indication for the scheduled PUSCH 505. Thus, symbol L2 may be defined with reference to whichever DCI message includes the SLIV of the two-stage DCI.

In some examples, the SLIV may be present in first DCI message 510-a. In such examples, symbol L2 may be defined as the next uplink symbol with its CP starting after the end of the reception of the last symbol of the PDCCH carrying the first DCI message 510-a scheduling PUSCH 505-a. In such examples, UE 115-a may transmit the uplink data message on PUSCH 505-a if L2 occurs after the last symbol of threshold offset value 520-a (e.g., after T_{proc2}). If offset 525-a has a duration that is long enough that symbol L2 occurs after expiration of threshold offset value 520-a, then UE 115-a may successfully transmit the uplink data message on PUSCH 505-a. In some examples, UE 115-a may determine that offset 525-a is greater than threshold offset value 520-a, and may transmit the data message based at least in part on the determining (e.g., or may refrain from transmitting if L2 occurs prior to expiration of T_{proc2}). In some examples, base station 105-a may schedule the uplink transmissions such that offset 525-a exceeds threshold offset value 520-a (e.g., or may refrain from scheduling PUSCHs such that L2 occurs prior to the expiration of T_{proc2}). In some examples, offset 525-a (e.g., and L2) may be determined with reference to first DCI message 510-a based on one or more rules, which may be defined in one or more standards documents, preconfigured at UE 115-a, indicated by base station 105-a, or any combination thereof.

In some examples, the SLIV may be present in second DCI message 515-b. In such examples, symbol L2 may be defined as the next uplink symbol with its CP starting after the end of the reception of the last symbol of the PDCCH carrying the second DCI message 515-b scheduling PUSCH 505-b. In such examples, UE 115-a may transmit the uplink data message on PUSCH 505-a if L2 occurs after the last symbol of threshold offset value 520-b (e.g., after T_{proc2}). If offset 525-b has a duration that is long enough that symbol L2 occurs after expiration of threshold offset value 520-b, then UE 115-a may successfully transmit the uplink data message on PUSCH 505-b. In some examples, UE 115-a may determine that offset 525-b is greater than threshold offset value 520-b, and may transmit the data message based at least in part on the determining (e.g., or may refrain from transmitting if L2 occurs prior to expiration of T_{proc2}). In some examples, base station 105-a may schedule the uplink transmissions such that offset 525-b exceeds threshold offset value 520-b (e.g., or may refrain from scheduling PUSCHs such that L2 occurs prior to the expiration of T_{proc2}). In some examples, offset 525-b (e.g., and L2) may be determined with reference to second DCI message 515-b based on one or more rules, which may be defined in one or more standards documents, preconfigured at UE 115-a, indicated by base station 105-a, or any combination thereof.

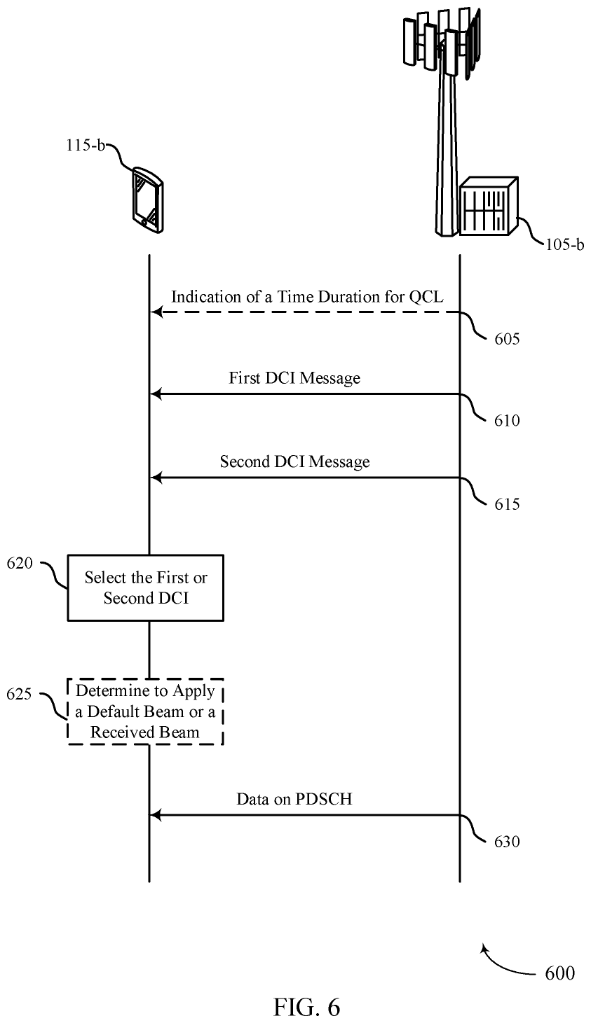

FIG. 6 illustrates an example of a process flow 600 that supports timing for two-stage DCI scheduled physical channels in accordance with one or more aspects of the present disclosure. The process flow 600 may implement aspects of the wireless communications systems 100 or 200, as described with reference to FIG. 1 and FIG. 2. Process flow 600 may include a UE 115-b and a base station 105-b, which may be examples of corresponding devices described with reference to FIGS. 1-5. In the following description of the process flow 600, the operations between UE 115-b and base station 105-b may be performed in different orders or at different times. Some operations may also be omitted from the process flow 600, and other operations may be added to the process flow 600.

At 605, UE 115-b may receive, from base station 105-b, an indication of a time duration during which a QCL relationship is valid (e.g., time DurationForQCL), the QCL relationship indicating that one or more antenna ports of the UE 115-b used to receive one or more reference signals are quasi co-located with one or more antenna ports of the UE 115-b used to receive downlink data.

At 610, UE 115-b may receive, from base station 105-b, a first DCI message of a two-stage set of DCI. In some examples, UE 115-b may receive a beam configuration indication in the first DCI message

At 615, UE 115-b may receive, from the base station 105-b, a second DCI message of the two-stage set of DCI, where the first DCI message and the second DCI message include scheduling information for a downlink data message on a physical downlink channel. In some examples, UE 115-b may receive, from the base station 105-b in the first DCI message or the second DCI message, a beam configuration indication comprising an indication of a receive beam for receiving a scheduled downlink message on the PDSCH at 630. In some examples, UE 115-b may receive a beam configuration indication in the second DCI message.

At 620, UE 115-b may select between the first DCI message and the second DCI message as a timing reference point. In some examples, UE 115-b may select the first DCI message as the timing reference point, where the timing offset includes a time period between a last TTI boundary of the first DCI message and a first TTI boundary of the downlink data message.

In some examples, where a beam configuration indication (e.g., a TCI state) is included in the first DCI message received at 610, selecting the first DCI message as a timing reference point is based on receiving the beam configuration indication in the first DCI message. In such examples, the timing offset may include a time period between a last TTI boundary of the first DCI message and a first TTI boundary of the downlink data message or the PDSCH carrying the downlink data message.

In some examples, the beam configuration indication (e.g., the TCI state) may be included in the second DCI message received at 615. In such examples, selecting the second DCI message as the timing reference point may be based on receiving the beam configuration indication in the second DCI message. In such examples, the timing offset may include a time period between a last TTI boundary of the second DCI message and a first TTI boundary of the downlink data message or the PDSCH carrying the downlink data message.

At 625, UE 115-b may compare a timing offset from the selected timing reference with the time duration, and select a receive beam on which to receive the downlink data message on the physical downlink channel based on the comparing. In some examples, UE 115-b may determine, based on the comparing, that the time duration is less than the timing offset, and may select the receive beam indicated by the beam configuration indication based on the determining (e.g., where the receive beam is not associated with the QCL relationship, but is indicated in the DCI). In some examples, UE 115-b may determine, based on the comparing, that the time duration is greater than the timing offset, and may select a default receive beam associated with the one or more reference signals according to the QCL relationship.

At 630, UE 115-b may receive, from the base station 105-b, the downlink data on the physical downlink channel based on the timing offset between the selected timing reference point and the scheduled downlink data. UE 115-b may receive the downlink data message using the receive beam selected at 625.

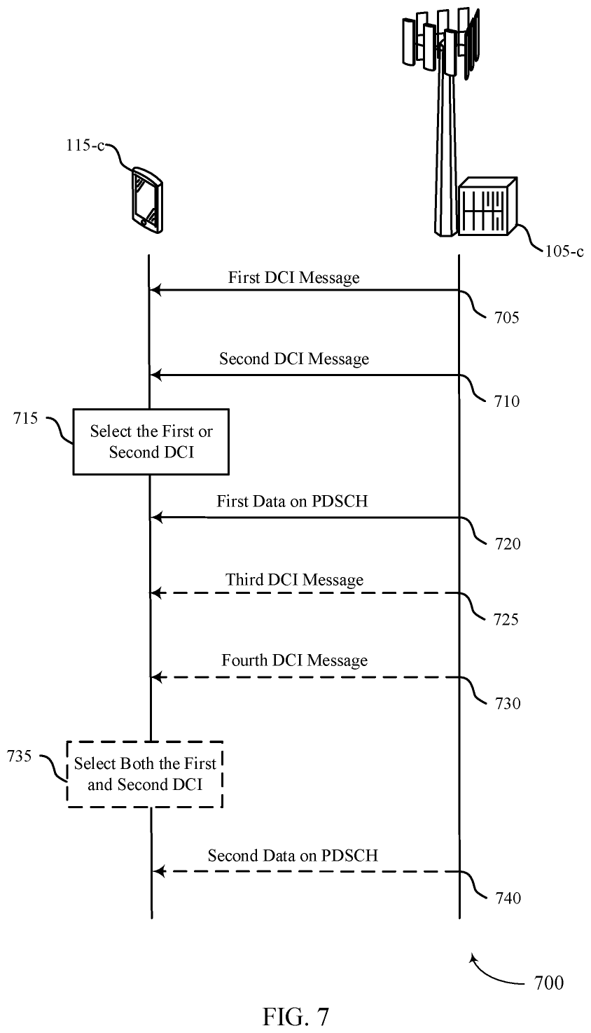

FIG. 7 illustrates an example of a process flow 700 that supports timing for two-stage DCI scheduled physical channels in accordance with one or more aspects of the present disclosure. The process flow 700 may implement aspects of the wireless communications systems 100 or 200, as described with reference to FIG. 1 and FIG. 2. Process flow 700 may include a UE 115-c and a base station 105-c, which may be examples of corresponding devices described with reference to FIGS. 1-6. In the following description of the process flow 700, the operations between UE 115-c and base station 105-c may be performed in different orders or at different times. Some operations may also be omitted from the process flow 700, and other operations may be added to the process flow 700.

At 705, UE 115-c may receive, from base station 105-c, a first DCI message of a two-stage set of DCI. In some examples, UE 115-c may receive, in the first DCI message, an indication of a starting point and a length of the downlink data message.

At 710, UE 115-c may receive, from the base station 105-c, a second DCI message of the two-stage set of DCI, where the first DCI message and the second DCI message include scheduling information for a downlink data message on a physical downlink channel. In some examples, UE 115-c may receive, in the second DCI message, an indication of a starting point and a length of the downlink data message,

At 715, UE 115-c may select between the first DCI message and the second DCI message as a timing reference point. In some examples, UE 115-c may select the first DCI message as the timing reference point, where the timing offset includes a time period between a last TTI boundary of the first DCI message and a first TTI boundary of the downlink data message. In some examples, UE 115-c may select the second DCI message as the timing reference point, where the timing offset includes a time period between a last TTI boundary of the second DCI message and a first TTI boundary of the downlink data message. The selecting may be based at least in part on one or more rules, which may be standardized, preconfigured, or indicated by base station 105-c.

In some examples, UE 115-c may select between the first DCI message and the second DCI message based at least in part on which DCI message includes an indication of a starting point and length for the first downlink control message. For instance, if the first DCI message received at 705 includes the indication of the starting point and length, then selecting the first DCI message as the timing reference point is based on receiving the indication of the starting point and the length in the first DCI message. In some examples, if the second DCI message received at 710 includes the indication of the starting point and the length of the downlink data message, selecting the second DCI message as the timing reference point is based on receiving the indication of the starting point and the length in the second DCI message.

At 720, UE 115-c may receive, from the base station 105-c, the downlink data on the physical downlink channel based on a timing offset between the selected timing reference point and the scheduled downlink data. In some examples, UE 115-c may receive the downlink data message on the physical downlink channel based on the timing offset from the selected timing reference point satisfying a threshold offset value.

At 725, UE 115-c may receive, from the base station 105-c, a third DCI message of a second two-stage set of DCI.

At 730, UE 115-c may receive, from the base station 105-c, a fourth DCI message of the second two-stage set of DCI, where the third DCI message and the fourth DCI message include scheduling information for a second downlink data message on a physical downlink channel.

At 735, UE 115-c may select both the first DCI message and the second DCI message as a second timing reference point, where a second timing offset includes a first time period between a last TTI boundary of the third DCI message and a first TTI boundary of the second downlink data message, and a second time period between a last TTI boundary of the fourth DCI message and the first TTI boundary of the second downlink data message.

At 740, UE 115-c may receive the second downlink data message on the physical downlink channel based on both the first time period and the second time period satisfying a threshold offset value.

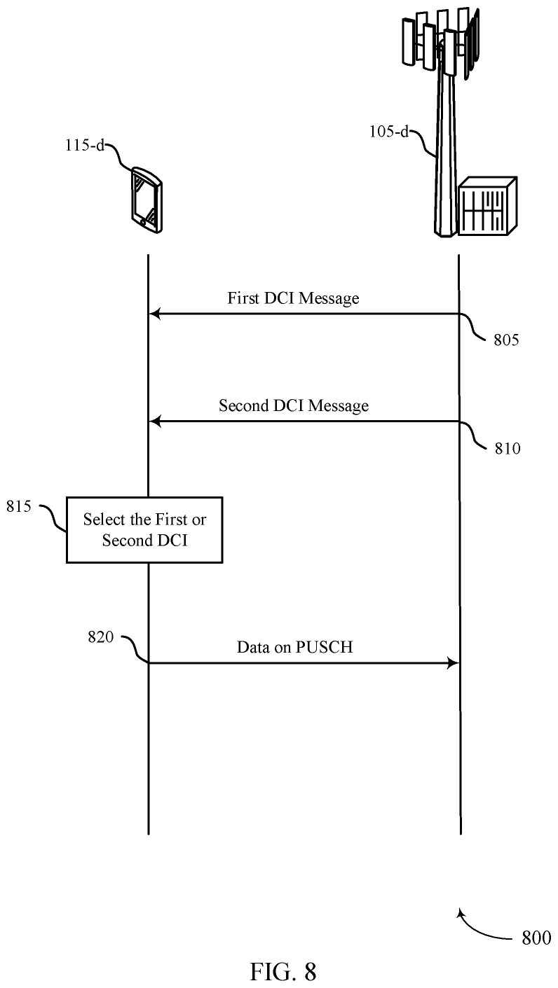

FIG. 8 illustrates an example of a process flow 800 that supports timing for two-stage DCI scheduled physical channels in accordance with one or more aspects of the present disclosure. The process flow 800 may implement aspects of the wireless communications systems 100 or 200, as described with reference to FIG. 1 and FIG. 2. Process flow 700 may include a UE 115-c and a base station 105-c, which may be examples of corresponding devices described with reference to FIGS. 1-7. In the following description of the process flow 800, the operations between UE 115-d and base station 105-d may be performed in different orders or at different times. Some operations may also be omitted from the process flow 800, and other operations may be added to the process flow 800.

At 805, UE 115-d may receive, from base station 105-d, a first DCI message of a two-stage set of DCI. In some examples, UE 115-d may receive, in the first DCI message, the indication of the starting point and the length of the uplink data message.

At 810, UE 115-d may receive, from the base station 105-d, a second DCI message of the two-stage set of DCI, where the first DCI message and the second DCI message include scheduling information for an uplink data message on a physical uplink channel. In some examples, UE 115-d may receive, in the second DCI message, the indication of the starting point and the length of the uplink data message.

At 815, UE 115-d may select between the first DCI message and the second DCI message as a timing reference point based on a location of an indication of a starting point and a length of the uplink data message.

If the indication of the starting point and the length of the uplink data is included in the first DCI message received at 805, then selecting the timing reference point may include selecting the first DCI message, and the timing offset may include a time period between a last TTI boundary of the first DCI message and a first TTI boundary of the uplink data message.

If the indication of the starting point and the length of the uplink data is included in the second DCI message received at 810, then selecting the timing reference point may include selecting the second DCI message, and the timing offset may include a time period between a last TTI boundary of the second DCI message and a first TTI boundary of the uplink data message.

At 820, UE 115-d may transmit, to the base station 105-d, the uplink data message on the physical uplink channel based on a timing offset between the selected timing reference point and the scheduled uplink data message satisfying a threshold offset value. In some examples, the threshold offset value may include a time duration between a last symbol of the selected timing reference point and a next symbol having a cyclic prefix that begins after the last symbol of the selected timing reference point.

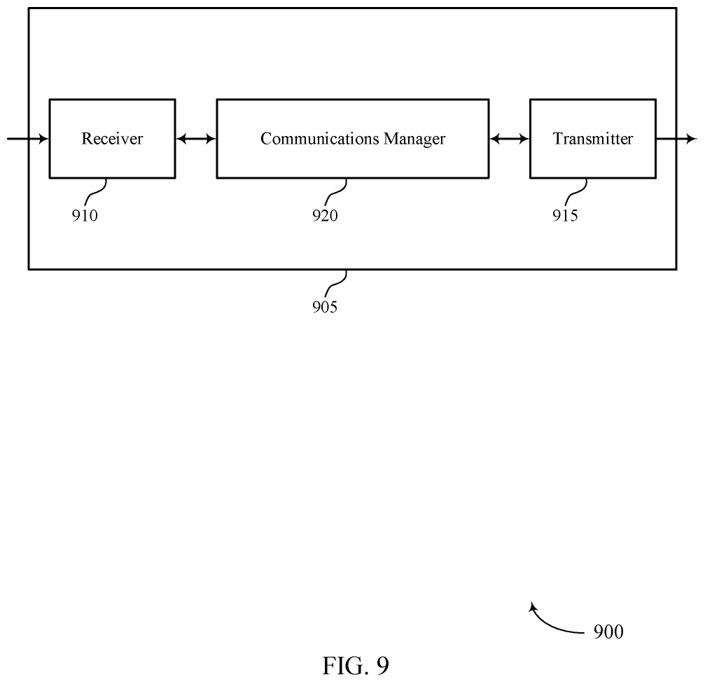

FIG. 9 shows a block diagram 900 of a device 905 that supports timing for two-stage DCI scheduled uplink channels in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to timing for two-stage DCI scheduled uplink channels). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to timing for two-stage DCI scheduled uplink channels). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of timing for two-stage DCI scheduled uplink channels as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for receiving, from a base station, a first DCI message of a two-stage set of DCI. The communications manager 920 may be configured as or otherwise support a means for receiving, from the base station, a second DCI message of the two-stage set of DCI, where the first DCI message and the second DCI message include scheduling information for a downlink data message on a physical downlink channel. The communications manager 920 may be configured as or otherwise support a means for selecting between the first DCI message and the second DCI message as a timing reference point. The communications manager 920 may be configured as or otherwise support a means for receiving, from the base station, the downlink data on the physical downlink channel based on a timing offset between the selected timing reference point and the scheduled downlink data.

Additionally or alternatively, the communications manager 920 may support wireless communications at a UE in accordance with examples as disclosed herein. For example, the communications manager 920 may be configured as or otherwise support a means for receiving, from a base station, a first DCI message of a two-stage set of DCI. The communications manager 920 may be configured as or otherwise support a means for receiving, from the base station, a second DCI message of the two-stage set of DCI, where the first DCI message and the second DCI message include scheduling information for an uplink data message on a physical uplink channel. The communications manager 920 may be configured as or otherwise support a means for selecting between the first DCI message and the second DCI message as a timing reference point based on a location of an indication of a starting point and a length of the uplink data message. The communications manager 920 may be configured as or otherwise support a means for transmitting, to the base station, the uplink data message on the physical uplink channel based on a timing offset between the selected timing reference point and the scheduled uplink data message satisfying a threshold offset value.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, and more efficient utilization of communication resources.

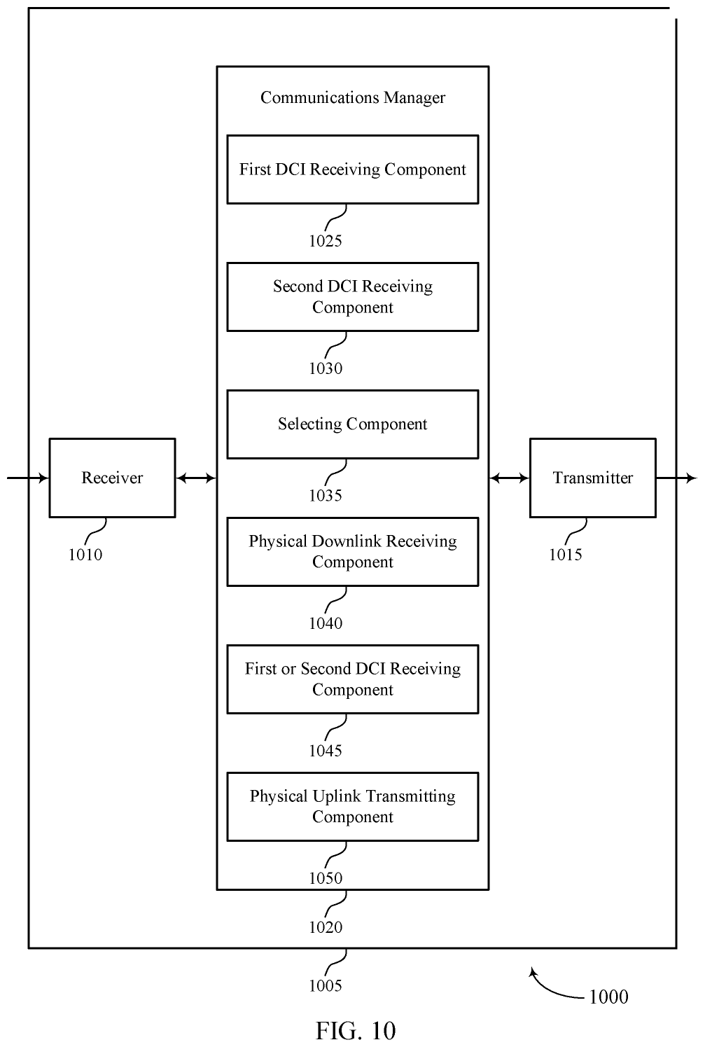

FIG. 10 shows a block diagram 1000 of a device 1005 that supports timing for two-stage DCI scheduled uplink channels in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to timing for two-stage DCI scheduled uplink channels). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to timing for two-stage DCI scheduled uplink channels). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of timing for two-stage DCI scheduled uplink channels as described herein. For example, the communications manager 1020 may include a first DCI receiving component 1025, a second DCI receiving component 1030, a selecting component 1035, a physical downlink receiving component 1040, a first or second DCI receiving component 1045, a physical uplink transmitting component 1050, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The first DCI receiving component 1025 may be configured as or otherwise support a means for receiving, from a base station, a first DCI message of a two-stage set of DCI. The second DCI receiving component 1030 may be configured as or otherwise support a means for receiving, from the base station, a second DCI message of the two-stage set of DCI, where the first DCI message and the second DCI message include scheduling information for a downlink data message on a physical downlink channel. The selecting component 1035 may be configured as or otherwise support a means for selecting between the first DCI message and the second DCI message as a timing reference point. The physical downlink receiving component 1040 may be configured as or otherwise support a means for receiving, from the base station, the downlink data on the physical downlink channel based on a timing offset between the selected timing reference point and the scheduled downlink data.

Additionally or alternatively, the communications manager 1020 may support wireless communications at a UE in accordance with examples as disclosed herein. The first DCI receiving component 1025 may be configured as or otherwise support a means for receiving, from a base station, a first DCI message of a two-stage set of DCI. The second DCI receiving component 1030 may be configured as or otherwise support a means for receiving, from the base station, a second DCI message of the two-stage set of DCI, where the first DCI message and the second DCI message include scheduling information for an uplink data message on a physical uplink channel. The first or second DCI receiving component 1045 may be configured as or otherwise support a means for selecting between the first DCI message and the second DCI message as a timing reference point based on a location of an indication of a starting point and a length of the uplink data message. The physical uplink transmitting component 1050 may be configured as or otherwise support a means for transmitting, to the base station, the uplink data message on the physical uplink channel based on a timing offset between the selected timing reference point and the scheduled uplink data message satisfying a threshold offset value.

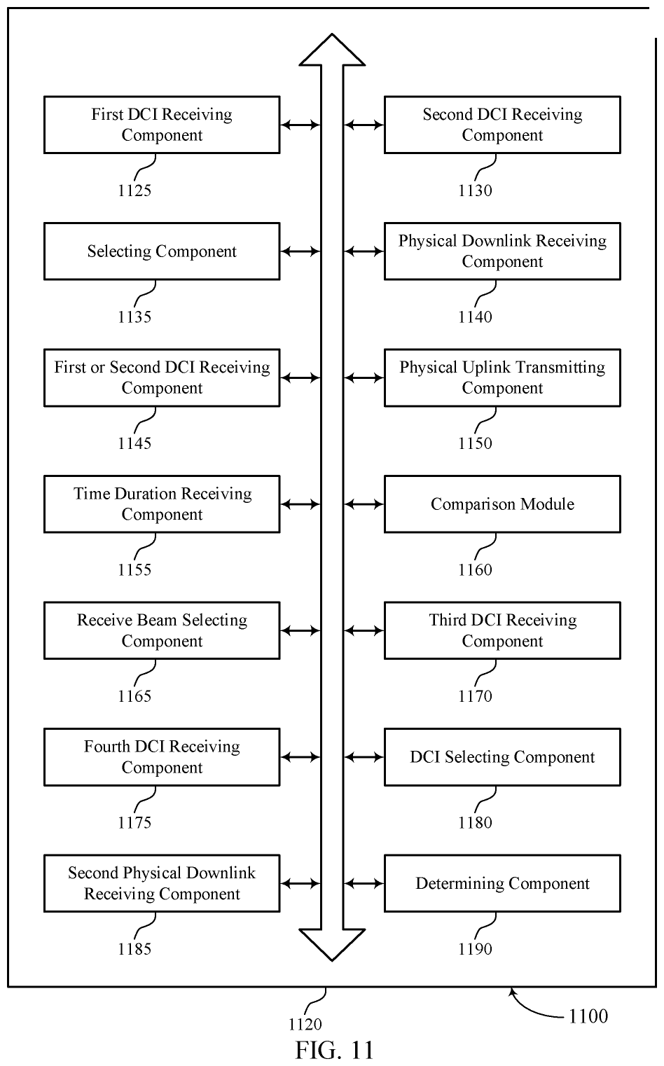

FIG. 11 shows a block diagram 1100 of a communications manager 1120 that supports timing for two-stage DCI scheduled uplink channels in accordance with aspects of the present disclosure. The communications manager 1120 may be an example of aspects of a communications manager 920, a communications manager 1020, or both, as described herein. The communications manager 1120, or various components thereof, may be an example of means for performing various aspects of timing for two-stage DCI scheduled uplink channels as described herein. For example, the communications manager 1120 may include a first DCI receiving component 1125, a second DCI receiving component 1130, a selecting component 1135, a physical downlink receiving component 1140, a first or second DCI receiving component 1145, a physical uplink transmitting component 1150, a time duration receiving component 1155, a comparison module 1160, a receive beam selecting component 1165, a third DCI receiving component 1170, a fourth DCI receiving component 1175, a DCI selecting component 1180, a second physical downlink receiving component 1185, a determining component 1190, or any combination thereof. Each of these components may communicate, directly or indirectly, with one another (e.g., via one or more buses).

The communications manager 1120 may support wireless communications at a UE in accordance with examples as disclosed herein. The first DCI receiving component 1125 may be configured as or otherwise support a means for receiving, from a base station, a first DCI message of a two-stage set of DCI. The second DCI receiving component 1130 may be configured as or otherwise support a means for receiving, from the base station, a second DCI message of the two-stage set of DCI, where the first DCI message and the second DCI message include scheduling information for a downlink data message on a physical downlink channel. The selecting component 1135 may be configured as or otherwise support a means for selecting between the first DCI message and the second DCI message as a timing reference point. The physical downlink receiving component 1140 may be configured as or otherwise support a means for receiving, from the base station, the downlink data on the physical downlink channel based on a timing offset between the selected timing reference point and the scheduled downlink data.

In some examples, the time duration receiving component 1155 may be configured as or otherwise support a means for receiving, from the base station, an indication of a time duration during which a QCL relationship is valid, the QCL relationship indicating that one or more antenna ports of the UE used to receive one or more reference signals are quasi co-located with one or more antenna ports of the UE used to receive the downlink data. In some examples, the comparison module 1160 may be configured as or otherwise support a means for comparing the timing offset from the selected timing reference with the time duration. In some examples, the receive beam selecting component 1165 may be configured as or otherwise support a means for selecting a receive beam on which to receive the downlink data message on the physical downlink channel based on the comparing.

In some examples, the first or second DCI receiving component 1145 may be configured as or otherwise support a means for receiving, from the base station in the first DCI message or the second DCI message, a beam configuration indication including an indication of the receive beam. In some examples, the determining component 1190 may be configured as or otherwise support a means for determining, based on the comparing, that the time duration is less than the timing offset, where selecting the receive beam indicated by the beam configuration indication is based on the determining, and where the receive beam is not associated with the QCL relationship.

In some examples, the determining component 1190 may be configured as or otherwise support a means for determining, based on the comparing, that the time duration is greater than the timing offset, where the receive beam includes a default receive beam associated with the one or more reference signals according to the QCL relationship.

In some examples, to support selecting, the selecting component 1135 may be configured as or otherwise support a means for selecting the first DCI message as the timing reference point, where the timing offset includes a time period between a last TTI boundary of the first DCI message and a first TTI boundary of the downlink data message.

In some examples, to support receiving the first DCI message, the first DCI receiving component 1125 may be configured as or otherwise support a means for receiving a beam configuration indication in the first DCI message, where selecting the first DCI message as the timing reference point is based on receiving the beam configuration indication in the first DCI message.

In some examples, to support selecting, the selecting component 1135 may be configured as or otherwise support a means for selecting the second DCI message as the timing reference point, and where the timing offset includes a time period between a last TTI boundary of the first DCI message and a first TTI boundary of the downlink data message.

In some examples, to support receiving the second DCI message, the second DCI receiving component 1130 may be configured as or otherwise support a means for receiving a beam configuration indication in the second DCI message, where selecting the second DCI message as the timing reference point is based on receiving the beam configuration indication in the first DCI message.

In some examples, to support communicating, the physical downlink receiving component 1140 may be configured as or otherwise support a means for receiving the downlink data message on the physical downlink channel based on the timing offset from the selected timing reference point satisfying a threshold offset value.

In some examples, to support selecting, the selecting component 1135 may be configured as or otherwise support a means for selecting the first DCI message as the timing reference point, where the timing offset includes a time period between a last TTI boundary of the first DCI message and a first TTI boundary of the downlink data message.

In some examples, to support receiving the first DCI message, the first DCI receiving component 1125 may be configured as or otherwise support a means for receiving, in the first DCI message, an indication of a starting point and a length of the downlink data message, where selecting the first DCI message as the timing reference point is based on receiving the indication of the starting point and the length in the first DCI message.

In some examples, the second DCI receiving component 1130 may be configured as or otherwise support a means for selecting the second DCI message as the timing reference point, where the timing offset includes a time period between a last TTI boundary of the second DCI message and a first TTI boundary of the downlink data message.

In some examples, the second DCI receiving component 1130 may be configured as or otherwise support a means for receiving, in the second DCI message, an indication of a starting point and a length of the downlink data message, where selecting the second DCI message as the timing reference point is based on receiving the indication of the starting point and the length in the second DCI message.

In some examples, the third DCI receiving component 1170 may be configured as or otherwise support a means for receiving, from the base station, a third DCI message of a second two-stage set of DCI. In some examples, the fourth DCI receiving component 1175 may be configured as or otherwise support a means for receiving, from the base station, a fourth DCI message of the second two-stage set of DCI, where the third DCI message and the fourth DCI message include scheduling information for a second downlink data message on a physical downlink channel. In some examples, the DCI selecting component 1180 may be configured as or otherwise support a means for selecting both the first DCI message and the second DCI message as a second timing reference point, where a second timing offset includes a first time period between a last TTI boundary of the third DCI message and a first TTI boundary of the second downlink data message, and a second time period between a last TTI boundary of the fourth DCI message and the first TTI boundary of the second downlink data message. In some examples, the second physical downlink receiving component 1185 may be configured as or otherwise support a means for receiving the second downlink data message on the physical downlink channel based on both the first time period and the second time period satisfying a threshold offset value.

Additionally or alternatively, the communications manager 1120 may support wireless communications at a UE in accordance with examples as disclosed herein. In some examples, the first DCI receiving component 1125 may be configured as or otherwise support a means for receiving, from a base station, a first DCI message of a two-stage set of DCI. In some examples, the second DCI receiving component 1130 may be configured as or otherwise support a means for receiving, from the base station, a second DCI message of the two-stage set of DCI, where the first DCI message and the second DCI message include scheduling information for an uplink data message on a physical uplink channel. The first or second DCI receiving component 1145 may be configured as or otherwise support a means for selecting between the first DCI message and the second DCI message as a timing reference point based on a location of an indication of a starting point and a length of the uplink data message. The physical uplink transmitting component 1150 may be configured as or otherwise support a means for transmitting, to the base station, the uplink data message on the physical uplink channel based on a timing offset between the selected timing reference point and the scheduled uplink data message satisfying a threshold offset value.

In some examples, the first DCI receiving component 1125 may be configured as or otherwise support a means for receiving, in the first DCI message, the indication of the starting point and the length of the uplink data message, where selecting the timing reference point includes selecting the first DCI message, and where the timing offset includes a time period between a last TTI boundary of the first DCI message and a first TTI boundary of the uplink data message.

In some examples, the second DCI receiving component 1130 may be configured as or otherwise support a means for receiving, in the second DCI message, the indication of the starting point and the length of the uplink data message, where selecting the timing reference point includes selecting the second DCI message, and where the timing offset includes a time period between a last TTI boundary of the second DCI message and a first TTI boundary of the uplink data message.

In some examples, the threshold offset value includes a time duration between a last symbol of the selected timing reference point and a next symbol having a cyclic prefix that begins after the last symbol of the selected timing reference point.

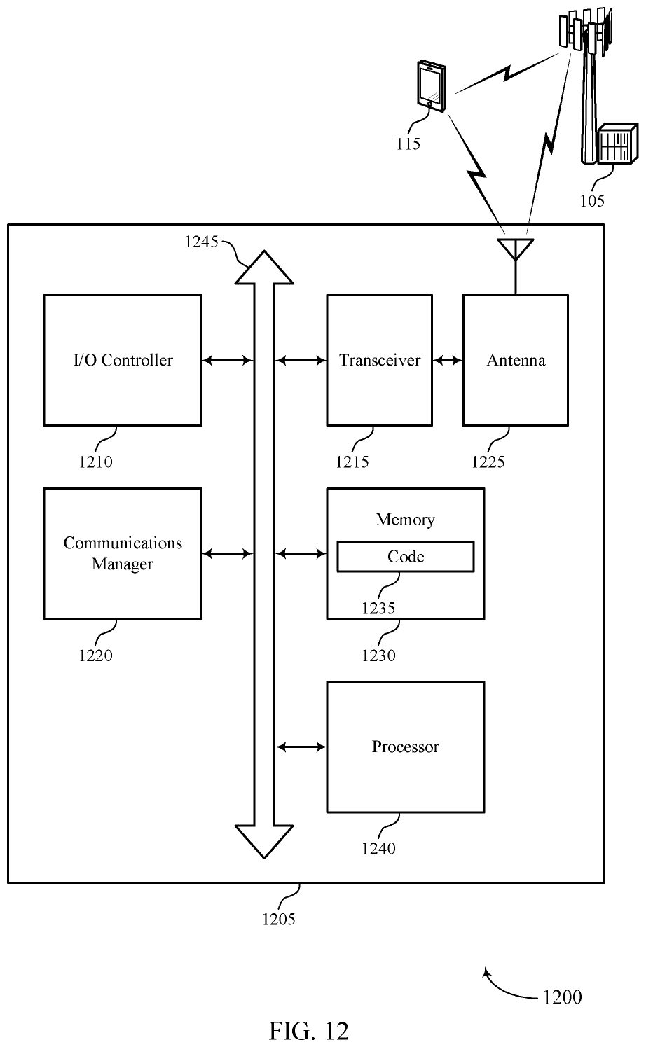

FIG. 12 shows a diagram of a system 1200 including a device 1205 that supports timing for two-stage DCI scheduled uplink channels in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting timing for two-stage DCI scheduled uplink channels). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving, from a base station, a first DCI message of a two-stage set of DCI. The communications manager 1220 may be configured as or otherwise support a means for receiving, from the base station, a second DCI message of the two-stage set of DCI, where the first DCI message and the second DCI message include scheduling information for a downlink data message on a physical downlink channel. The communications manager 1220 may be configured as or otherwise support a means for selecting between the first DCI message and the second DCI message as a timing reference point. The communications manager 1220 may be configured as or otherwise support a means for receiving, from the base station, the downlink data on the physical downlink channel based on a timing offset between the selected timing reference point and the scheduled downlink data.

Additionally or alternatively, the communications manager 1220 may support wireless communications at a UE in accordance with examples as disclosed herein. For example, the communications manager 1220 may be configured as or otherwise support a means for receiving, from a base station, a first DCI message of a two-stage set of DCI. The communications manager 1220 may be configured as or otherwise support a means for receiving, from the base station, a second DCI message of the two-stage set of DCI, where the first DCI message and the second DCI message include scheduling information for an uplink data message on a physical uplink channel. The communications manager 1220 may be configured as or otherwise support a means for selecting between the first DCI message and the second DCI message as a timing reference point based on a location of an indication of a starting point and a length of the uplink data message. The communications manager 1220 may be configured as or otherwise support a means for transmitting, to the base station, the uplink data message on the physical uplink channel based on a timing offset between the selected timing reference point and the scheduled uplink data message satisfying a threshold offset value.

By including or configuring the communications manager 1220 in accordance with examples as described herein, the device 1205 may support techniques for uplink and downlink signaling resulting in improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of timing for two-stage DCI scheduled uplink channels as described herein, or the processor 1240 and the memory 1230 may be otherwise configured to perform or support such operations.

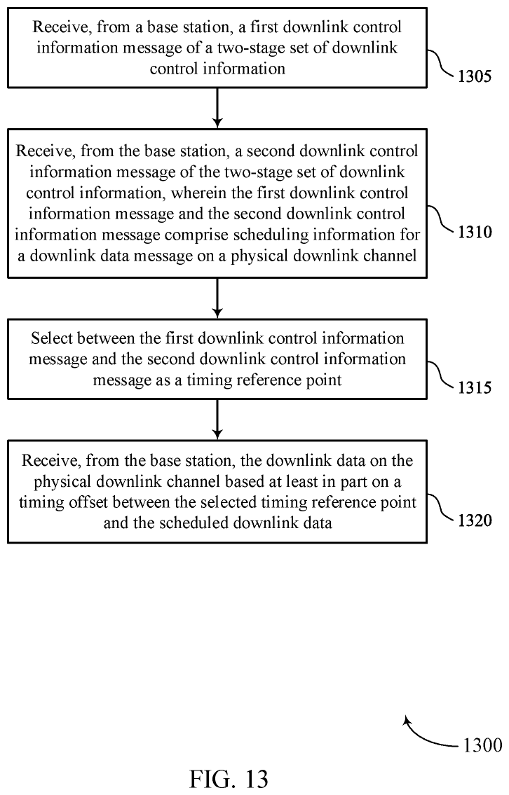

FIG. 13 shows a flowchart illustrating a method 1300 that supports timing for two-stage DCI scheduled uplink channels in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, a first DCI message of a two-stage set of DCI. The operations of 1305 may be performed in accordance with examples as disclosed herein. In some examples, aspects of the operations of 1305 may be performed by a first DCI receiving component 1125 as described with reference to FIG. 11.

At 1310, the method may include receiving, from the base station, a second DCI message of the two-stage set of DCI, where the first DCI message and the second DCI message include scheduling information for a downlink data message on a physical downlink channel. The operations of 1310 may be performed in accordance with examples as disclosed herein. In some examples, aspects of the operations of 1310 may be performed by a second DCI receiving component 1130 as described with reference to FIG. 11.

At 1315, the method may include selecting between the first DCI message and the second DCI message as a timing reference point. The operations of 1315 may be performed in accordance with examples as disclosed herein. In some examples, aspects of the operations of 1315 may be performed by a selecting component 1135 as described with reference to FIG. 11.

At 1320, the method may include receiving, from the base station, the downlink data on the physical downlink channel based on a timing offset between the selected timing reference point and the scheduled downlink data. The operations of 1320 may be performed in accordance with examples as disclosed herein. In some examples, aspects of the operations of 1320 may be performed by a physical downlink receiving component 1140 as described with reference to FIG. 11.

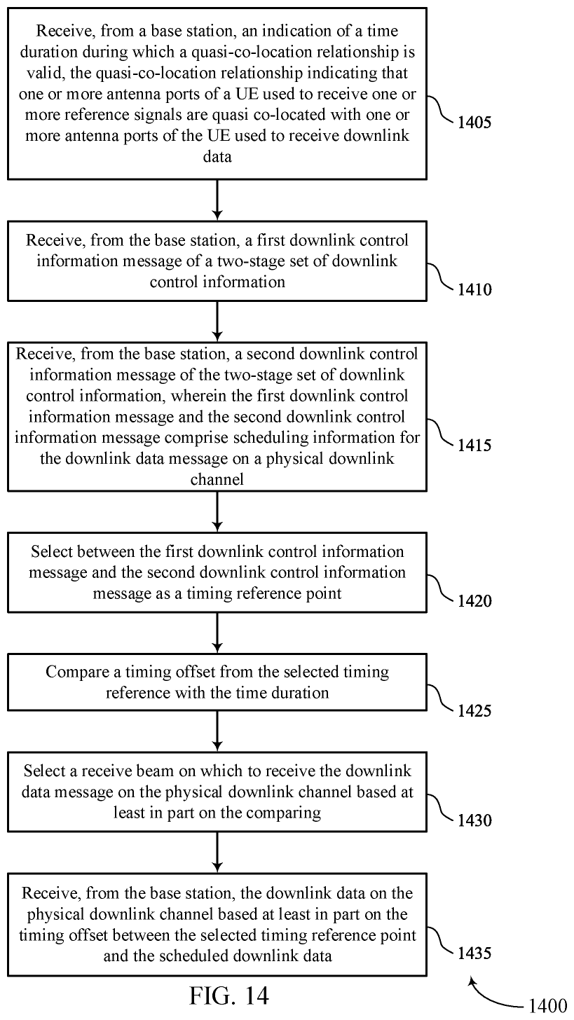

FIG. 14 shows a flowchart illustrating a method 1400 that supports timing for two-stage DCI scheduled uplink channels in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, an indication of a time duration during which a QCL relationship is valid, the QCL relationship indicating that one or more antenna ports of a UE used to receive one or more reference signals are quasi co-located with one or more antenna ports of the UE used to receive downlink data. The operations of 1405 may be performed in accordance with examples as disclosed herein. In some examples, aspects of the operations of 1405 may be performed by a time duration receiving component 1155 as described with reference to FIG. 11.

At 1410, the method may include receiving, from a base station, a first DCI message of a two-stage set of DCI. The operations of 1410 may be performed in accordance with examples as disclosed herein. In some examples, aspects of the operations of 1410 may be performed by a first DCI receiving component 1125 as described with reference to FIG. 11.

At 1415, the method may include receiving, from the base station, a second DCI message of the two-stage set of DCI, where the first DCI message and the second DCI message include scheduling information for the downlink data message on a physical downlink channel. The operations of 1415 may be performed in accordance with examples as disclosed herein. In some examples, aspects of the operations of 1415 may be performed by a second DCI receiving component 1130 as described with reference to FIG. 11.

At 1420, the method may include selecting between the first DCI message and the second DCI message as a timing reference point. The operations of 1420 may be performed in accordance with examples as disclosed herein. In some examples, aspects of the operations of 1420 may be performed by a selecting component 1135 as described with reference to FIG. 11.

At 1425, the method may include comparing a timing offset from the selected timing reference with the time duration. The operations of 1425 may be performed in accordance with examples as disclosed herein. In some examples, aspects of the operations of 1425 may be performed by a comparison module 1160 as described with reference to FIG. 11.

At 1430, the method may include selecting a receive beam on which to receive the downlink data message on the physical downlink channel based on the comparing. The operations of 1430 may be performed in accordance with examples as disclosed herein. In some examples, aspects of the operations of 1430 may be performed by a receive beam selecting component 1165 as described with reference to FIG. 11.

At 1435, the method may include receiving, from the base station, the downlink data on the physical downlink channel based on the timing offset between the selected timing reference point and the scheduled downlink data. The operations of 1435 may be performed in accordance with examples as disclosed herein. In some examples, aspects of the operations of 1435 may be performed by a physical downlink receiving component 1140 as described with reference to FIG. 11.

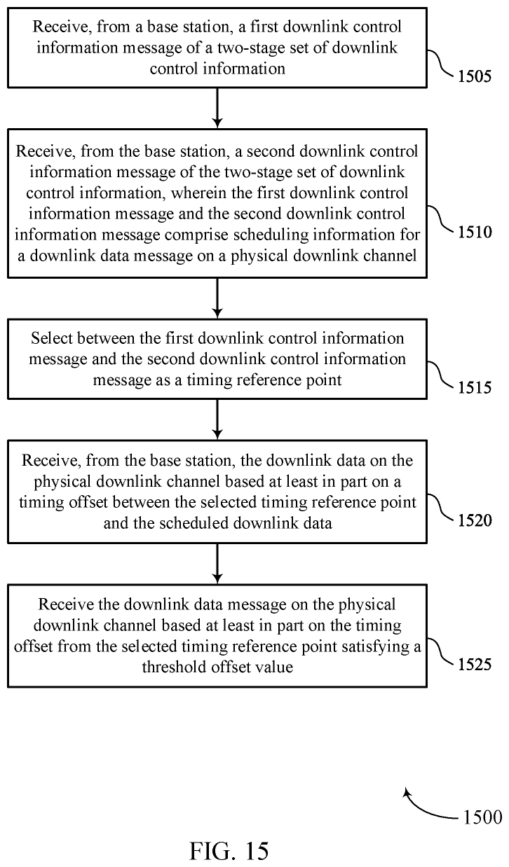

FIG. 15 shows a flowchart illustrating a method 1500 that supports timing for two-stage DCI scheduled uplink channels in accordance with aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a first DCI message of a two-stage set of DCI. The operations of 1505 may be performed in accordance with examples as disclosed herein. In some examples, aspects of the operations of 1505 may be performed by a first DCI receiving component 1125 as described with reference to FIG. 11.

At 1510, the method may include receiving, from the base station, a second DCI message of the two-stage set of DCI, where the first DCI message and the second DCI message include scheduling information for a downlink data message on a physical downlink channel. The operations of 1510 may be performed in accordance with examples as disclosed herein. In some examples, aspects of the operations of 1510 may be performed by a second DCI receiving component 1130 as described with reference to FIG. 11.

At 1515, the method may include selecting between the first DCI message and the second DCI message as a timing reference point. The operations of 1515 may be performed in accordance with examples as disclosed herein. In some examples, aspects of the operations of 1515 may be performed by a selecting component 1135 as described with reference to FIG. 11.

At 1520, the method may include receiving, from the base station, the downlink data on the physical downlink channel based on a timing offset between the selected timing reference point and the scheduled downlink data. The operations of 1520 may be performed in accordance with examples as disclosed herein. In some examples, aspects of the operations of 1520 may be performed by a physical downlink receiving component 1140 as described with reference to FIG. 11.

At 1525, the method may include receiving the downlink data message on the physical downlink channel based on the timing offset from the selected timing reference point satisfying a threshold offset value. The operations of 1525 may be performed in accordance with examples as disclosed herein. In some examples, aspects of the operations of 1525 may be performed by a physical downlink receiving component 1140 as described with reference to FIG. 11.

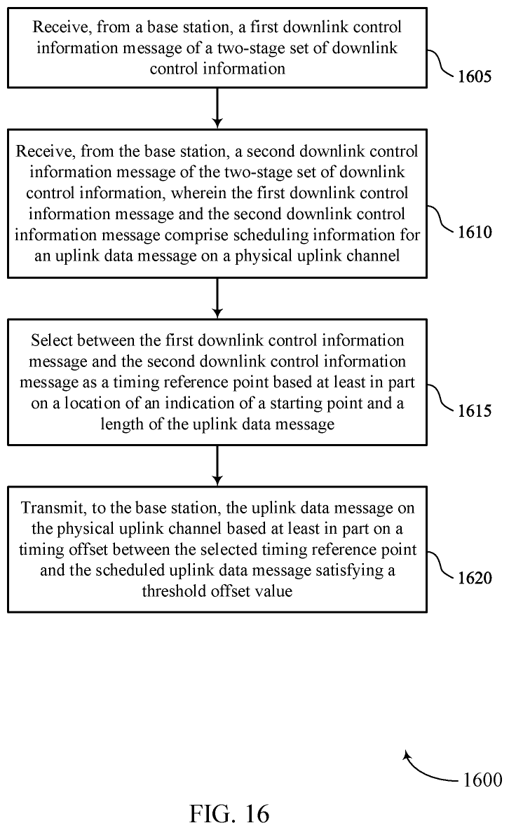

FIG. 16 shows a flowchart illustrating a method 1600 that supports timing for two-stage DCI scheduled uplink channels in accordance with aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, a first DCI message of a two-stage set of DCI. The operations of 1605 may be performed in accordance with examples as disclosed herein. In some examples, aspects of the operations of 1605 may be performed by a first DCI receiving component 1125 as described with reference to FIG. 11.

At 1610, the method may include receiving, from the base station, a second DCI message of the two-stage set of DCI, where the first DCI message and the second DCI message include scheduling information for an uplink data message on a physical uplink channel. The operations of 1610 may be performed in accordance with examples as disclosed herein. In some examples, aspects of the operations of 1610 may be performed by a second DCI receiving component 1130 as described with reference to FIG. 11.

At 1615, the method may include selecting between the first DCI message and the second DCI message as a timing reference point based on a location of an indication of a starting point and a length of the uplink data message. The operations of 1615 may be performed in accordance with examples as disclosed herein. In some examples, aspects of the operations of 1615 may be performed by a first or second DCI receiving component 1145 as described with reference to FIG. 11.

At 1620, the method may include transmitting, to the base station, the uplink data message on the physical uplink channel based on a timing offset between the selected timing reference point and the scheduled uplink data message satisfying a threshold offset value. The operations of 1620 may be performed in accordance with examples as disclosed herein. In some examples, aspects of the operations of 1620 may be performed by a physical uplink transmitting component 1150 as described with reference to FIG. 11.

The following provides an overview of aspects of the present disclosure:

Aspect 1: A method for wireless communications at a UE, comprising: receiving, from a base station, a first DCI message of a two-stage set of DCI; receiving, from the base station, a second DCI message of the two-stage set of DCI, wherein the first DCI message and the second DCI message comprise scheduling information for downlink data message on a physical downlink channel; selecting between the first DCI message and the second DCI message as a timing reference point; and receiving, from the base station, the downlink data on the physical downlink channel based at least in part on a timing offset between the selected timing reference point and the scheduled downlink data.

Aspect 2: The method of aspect 1, further comprising: receiving, from the base station, an indication of a time duration during which a QCL relationship is valid, the QCL relationship indicating that one or more antenna ports of the UE used to receive one or more reference signals are quasi co-located with one or more antenna ports of the UE used to receive the downlink data; comparing the timing offset from the selected timing reference with the time duration; and selecting a receive beam on which to receive the downlink data message on the physical downlink channel based at least in part on the comparing.

Aspect 3: The method of aspect 2, further comprising: receiving, from the base station in the first DCI message or the second DCI message, a beam configuration indication comprising an indication of the receive beam; and determining, based at least in part on the comparing, that the time duration is less than the timing offset, wherein selecting the receive beam indicated by the beam configuration indication is based at least in part on the determining, and wherein the receive beam is not associated with the QCL relationship.

Aspect 4: The method of any of aspects 2 through 3, further comprising: determining, based at least in part on the comparing, that the time duration is greater than the timing offset, wherein the receive beam comprises a default receive beam associated with the one or more reference signals according to the QCL relationship.

Aspect 5: The method of any of aspects 2 through 4, wherein the selecting comprises: selecting the first DCI message as the timing reference point, wherein the timing offset comprises a time period between a last TTI boundary of the first DCI message and a first TTI boundary of the downlink data message.

Aspect 6: The method of aspect 5, wherein receiving the first DCI message comprises: receiving a beam configuration indication in the first DCI message, wherein selecting the first DCI message as the timing reference point is based at least in part on receiving the beam configuration indication in the first DCI message.

Aspect 7: The method of any of aspects 2 through 6, wherein the selecting comprises: selecting the second DCI message as the timing reference point, and wherein the timing offset comprises a time period between a last TTI boundary of the first DCI message and a first TTI boundary of the downlink data message.

Aspect 8: The method of aspect 7, wherein receiving the second DCI message comprises: receiving a beam configuration indication in the second DCI message, wherein selecting the second DCI message as the timing reference point is based at least in part on receiving the beam configuration indication in the first DCI message.

Aspect 9: The method of any of aspects 1 through 8, wherein the communicating comprises: receiving the downlink data message on the physical downlink channel based at least in part on the timing offset from the selected timing reference point satisfying a threshold offset value.

Aspect 10: The method of aspect 9, wherein the selecting comprises: selecting the first DCI message as the timing reference point, wherein the timing offset comprises a time period between a last TTI boundary of the first DCI message and a first TTI boundary of the downlink data message.

Aspect 11: The method of aspect 10, wherein receiving the first DCI message comprises: receiving, in the first DCI message, an indication of a starting point and a length of the downlink data message, wherein selecting the first DCI message as the timing reference point is based at least in part on receiving the indication of the starting point and the length in the first DCI message.

Aspect 12: The method of any of aspects 9 through 11, further comprising: selecting the second DCI message as the timing reference point, wherein the timing offset comprises a time period between a last TTI boundary of the second DCI message and a first TTI boundary of the downlink data message.

Aspect 13: The method of aspect 12, further comprising: receiving, in the second DCI message, an indication of a starting point and a length of the downlink data message, wherein selecting the second DCI message as the timing reference point is based at least in part on receiving the indication of the starting point and the length in the second DCI message.

Aspect 14: The method of any of aspects 1 through 13, further comprising: receiving, from the base station, a third DCI message of a second two-stage set of DCI; receiving, from the base station, a fourth DCI message of the second two-stage set of DCI, wherein the third DCI message and the fourth DCI message comprise scheduling information for a second downlink data message on a physical downlink channel; selecting both the first DCI message and the second DCI message as a second timing reference point, wherein a second timing offset comprises a first time period between a last TTI boundary of the third DCI message and a first TTI boundary of the second downlink data message, and a second time period between a last TTI boundary of the fourth DCI message and the first TTI boundary of the second downlink data message; and receiving the second downlink data message on the physical downlink channel based at least in part on both the first time period and the second time period satisfying a threshold offset value.

Aspect 15: A method for wireless communications at a UE, comprising: receiving, from a base station, a first DCI message of a two-stage set of DCI; receiving, from the base station, a second DCI message of the two-stage set of DCI, wherein the first DCI message and the second DCI message comprise scheduling information for uplink data message on a physical uplink channel; selecting between the first DCI message and the second DCI message as a timing reference point based at least in part on a location of an indication of a starting point and a length of the uplink data message; and transmitting, to the base station, the uplink data message on the physical uplink channel based at least in part on a timing offset between the selected timing reference point and the scheduled uplink data message satisfying a threshold offset value.

Aspect 16: The method of aspect 15, further comprising: receiving, in the first DCI message, the indication of the starting point and the length of the uplink data message, wherein selecting the timing reference point comprises selecting the first DCI message, and wherein the timing offset comprises a time period between a last TTI boundary of the first DCI message and a first TTI boundary of the uplink data message.

Aspect 17: The method of any of aspects 15 through 16, further comprising: receiving, in the second DCI message, the indication of the starting point and the length of the uplink data message, wherein selecting the timing reference point comprises selecting the second DCI message, and wherein the timing offset comprises a time period between a last TTI boundary of the second DCI message and a first TTI boundary of the uplink data message.

Aspect 18: The method of any of aspects 15 through 17, wherein the threshold offset value comprises a time duration between a last symbol of the selected timing reference point and a next symbol having a cyclic prefix that begins after the last symbol of the selected timing reference point.

Aspect 19: An apparatus for wireless communications at a UE, comprising a processor; memory coupled with the processor; and instructions stored in the memory and executable by the processor to cause the apparatus to perform a method of any of aspects 1 through 14.

Aspect 20: An apparatus for wireless communications at a UE, comprising at least one means for performing a method of any of aspects 1 through 14.

Aspect 21: A non-transitory computer-readable medium storing code for wireless communications at a UE, the code comprising instructions executable by a processor to perform a method of any of aspects 1 through 14.

Aspect 22: An apparatus for wireless communications at a UE, comprising a processor; memory coupled with the processor; and instructions stored in the memory and executable by the processor to cause the apparatus to perform a method of any of aspects 15 through 18.

Aspect 23: An apparatus for wireless communications at a UE, comprising at least one means for performing a method of any of aspects 15 through 18.

Aspect 24: A non-transitory computer-readable medium storing code for wireless communications at a UE, the code comprising instructions executable by a processor to perform a method of any of aspects 15 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a first downlink control information message of a two-stage set of downlink control information;
receiving, from the base station, a second downlink control information message of the two-stage set of downlink control information, wherein the first downlink control information message and the second downlink control information message comprise scheduling information for a downlink data message on a physical downlink channel;
selecting between the first downlink control information message and the second downlink control information message as a timing reference point; and
receiving, from the base station, the downlink data on the physical downlink channel based at least in part on a timing offset between the selected timing reference point and the scheduled downlink data.

2. The method of claim 1, further comprising:
receiving, from the base station, an indication of a time duration during which a quasi-co-location relationship is valid, the quasi-co-location relationship indicating that one or more antenna ports of the UE used to receive one or more reference signals are quasi co-located with one or more antenna ports of the UE used to receive the downlink data;
comparing the timing offset from the selected timing reference with the time duration; and
selecting a receive beam on which to receive the downlink data message on the physical downlink channel based at least in part on the comparing.

3. The method of claim 2, further comprising:
receiving, from the base station in the first downlink control information message or the second downlink control information message, a beam configuration indication comprising an indication of the receive beam; and
determining, based at least in part on the comparing, that the time duration is less than the timing offset, wherein selecting the receive beam indicated by the beam configuration indication is based at least in part on the determining, and wherein the receive beam is not associated with the quasi-co-location relationship.

4. The method of claim 2, further comprising:
determining, based at least in part on the comparing, that the time duration is greater than the timing offset, wherein the receive beam comprises a default receive beam associated with the one or more reference signals according to the quasi-co-location relationship.

5. The method of claim 2, wherein the selecting comprises:
selecting the first downlink control information message as the timing reference point, wherein the timing offset comprises a time period between a last transmission time interval boundary of the first downlink control information message and a first transmission time interval boundary of the downlink data message.

6. The method of claim 5, wherein receiving the first downlink control information message comprises:
receiving a beam configuration indication in the first downlink control information message, wherein selecting the first downlink control information message as the timing reference point is based at least in part on receiving the beam configuration indication in the first downlink control information message.

7. The method of claim 2, wherein the selecting comprises:
selecting the second downlink control information message as the timing reference point, and wherein the timing offset comprises a time period between a last transmission time interval boundary of the first downlink control information message and a first transmission time interval boundary of the downlink data message.

8. The method of claim 7, wherein receiving the second downlink control information message comprises:
receiving a beam configuration indication in the second downlink control information message, wherein selecting the second downlink control information message as the timing reference point is based at least in part on receiving the beam configuration indication in the first downlink control information message.

9. The method of claim 1, wherein the communicating comprises:
receiving the downlink data message on the physical downlink channel based at least in part on the timing offset from the selected timing reference point satisfying a threshold offset value.

10. The method of claim 9, wherein the selecting comprises:
selecting the first downlink control information message as the timing reference point, wherein the timing offset comprises a time period between a last transmission time interval boundary of the first downlink control information message and a first transmission time interval boundary of the downlink data message.

11. The method of claim 10, wherein receiving the first downlink control information message comprises:
receiving, in the first downlink control information message, an indication of a starting point and a length of the downlink data message, wherein selecting the first downlink control information message as the timing reference point is based at least in part on receiving the indication of the starting point and the length in the first downlink control information message.

12. The method of claim 9, further comprising:
selecting the second downlink control information message as the timing reference point, wherein the timing offset comprises a time period between a last transmission time interval boundary of the second downlink control information message and a first transmission time interval boundary of the downlink data message.

13. The method of claim 12, further comprising:
receiving, in the second downlink control information message, an indication of a starting point and a length of the downlink data message, wherein selecting the second downlink control information message as the timing reference point is based at least in part on receiving the indication of the starting point and the length in the second downlink control information message.

14. The method of claim 1, further comprising:
receiving, from the base station, a third downlink control information message of a second two-stage set of downlink control information;
receiving, from the base station, a fourth downlink control information message of the second two-stage set of downlink control information, wherein the third downlink control information message and the fourth downlink control information message comprise scheduling information for a second downlink data message on a physical downlink channel;
selecting both the first downlink control information message and the second downlink control information message as a second timing reference point, wherein a second timing offset comprises a first time period between a last transmission time interval boundary of the third downlink control information message and a first transmission time interval boundary of the second downlink data message, and a second time period between a last transmission time interval boundary of the fourth downlink control information message and the first transmission time interval boundary of the second downlink data message; and
receiving the second downlink data message on the physical downlink channel based at least in part on both the first time period and the second time period satisfying a threshold offset value.

15. A method for wireless communications at a user equipment (UE), comprising:
receiving, from a base station, a first downlink control information message of a two-stage set of downlink control information;
receiving, from the base station, a second downlink control information message of the two-stage set of downlink control information, wherein the first downlink control information message and the second downlink control information message comprise scheduling information for an uplink data message on a physical uplink channel;
selecting between the first downlink control information message and the second downlink control information message as a timing reference point based at least in part on a location of an indication of a starting point and a length of the uplink data message; and
transmitting, to the base station, the uplink data message on the physical uplink channel based at least in part on a timing offset between the selected timing reference point and the scheduled uplink data message satisfying a threshold offset value.

16. The method of claim 15, further comprising:
receiving, in the first downlink control information message, the indication of the starting point and the length of the uplink data message, wherein selecting the timing reference point comprises selecting the first downlink control information message, and wherein the timing offset comprises a time period between a last transmission time interval boundary of the first downlink control information message and a first transmission time interval boundary of the uplink data message.

17. The method of claim 15, further comprising:
receiving, in the second downlink control information message, the indication of the starting point and the length of the uplink data message, wherein selecting the timing reference point comprises selecting the second downlink control information message, and wherein the timing offset comprises a time period between a last transmission time interval boundary of the second downlink control information message and a first transmission time interval boundary of the uplink data message.

18. The method of claim 15, wherein the threshold offset value comprises a time duration between a last symbol of the selected timing reference point and a next symbol having a cyclic prefix that begins after the last symbol of the selected timing reference point.

19. An apparatus for wireless communications at a user equipment (UE), comprising:
a processor;
memory coupled with the processor;
instructions stored in the memory and executable by the processor to cause the apparatus to;
receive, from a base station, a first downlink control information message of a two-stage set of downlink control information;
receive, from the base station, a second downlink control information message of the two-stage set of downlink control information, wherein the first downlink control information message and the second downlink control information message comprise scheduling information for a downlink transmission on a physical downlink channel;
select between the first downlink control information message and the second downlink control information message as a timing reference point; and
receive, from the base station, the downlink transmission on the physical downlink channel based at least in part on a timing offset between the selected timing reference point and the scheduled downlink transmission.

20. The apparatus of claim 19, wherein the instructions are further executable by the processor to cause the apparatus to:
receive, from the base station, an indication of a time duration during which a quasi-co-location relationship is valid, the quasi-co-location relationship indicating that one or more antenna ports of the UE used to receive one or more reference signals are quasi co-located with one or more antenna ports of the UE used to receive the downlink transmission;
compare the timing offset from the selected timing reference with the time duration; and
select a receive beam on which to receive the downlink transmission on the physical downlink channel based at least in part on the comparing.

21. The apparatus of claim 20, wherein the instructions are further executable by the processor to cause the apparatus to:
receive, from the base station in the first downlink control information message or the second downlink control information message, a beam configuration indication comprising an indication of the receive beam; and
determine, based at least in part on the comparing, that the time duration is less than the timing offset, wherein selecting the receive beam indicated by the beam configuration indication is based at least in part on the determining, and wherein the receive beam is not associated with the quasi-co-location relationship.

22. The apparatus of claim 20, wherein the instructions are further executable by the processor to cause the apparatus to:
determine, based at least in part on the comparing, that the time duration is greater than the timing offset, wherein the receive beam comprises a default receive beam associated with the one or more reference signals according to the quasi-co-location relationship.

23. The apparatus of claim 20, wherein the instructions to select are executable by the processor to cause the apparatus to:
receive a beam configuration indication in the first downlink control information message; and
select the first downlink control information message as the timing reference point, wherein the timing offset comprises a time period between a last transmission time interval boundary of the first downlink control information message and a first transmission time interval boundary of the downlink transmission, wherein selecting the first downlink control information message as the timing reference point is based at least in part on receiving the beam configuration indication in the first downlink control information message.

24. The apparatus of claim 20, wherein the instructions to select are executable by the processor to cause the apparatus to:
receive a beam configuration indication in the second downlink control information message; and
select the second downlink control information message as the timing reference point, and wherein the timing offset comprises a time period between a last transmission time interval boundary of the first downlink control information message and a first transmission time interval boundary of the downlink transmission, wherein selecting the second downlink control information message as the timing reference point is based at least in part on receiving the beam configuration indication in the first downlink control information message.

25. The apparatus of claim 19, wherein the instructions to are executable by the processor to cause the apparatus to:
receive the downlink transmission on the physical downlink channel based at least in part on the timing offset from the selected timing reference point satisfying a threshold offset value.

26. The apparatus of claim 25, wherein the instructions to select are executable by the processor to cause the apparatus to:
receive, in the first downlink control information message, an indication of a starting point and a length of the downlink transmission; and
select the first downlink control information message as the timing reference point, wherein the timing offset comprises a time period between a last transmission time interval boundary of the first downlink control information message and a first transmission time interval boundary of the downlink transmission, wherein selecting the first downlink control information message as the timing reference point is based at least in part on receiving the indication of the starting point and the length in the first downlink control information message.

27. The apparatus of claim 25, wherein the instructions are further executable by the processor to cause the apparatus to:
receive, in the second downlink control information message, an indication of a starting point and a length of the downlink transmission; and
select the second downlink control information message as the timing reference point, wherein the timing offset comprises a time period between a last transmission time interval boundary of the second downlink control information message and a first transmission time interval boundary of the downlink transmission, wherein selecting the second downlink control information message as the timing reference point is based at least in part on receiving the indication of the starting point and the length in the second downlink control information message.

28. An apparatus for wireless communications at a user equipment (UE), comprising:
a processor;
memory coupled with the processor;
instructions stored in the memory and executable by the processor to cause the apparatus to;
receive, from a base station, a first downlink control information message of a two-stage set of downlink control information;
receive, from the base station, a second downlink control information message of the two-stage set of downlink control information, wherein the first downlink control information message and the second downlink control information message comprise scheduling information for an uplink data message on a physical uplink channel;
select between the first downlink control information message and the second downlink control information message as a timing reference point based at least in part on a location of an indication of a starting point and a length of the uplink data message; and
transmit, to the base station, the uplink data message on the physical uplink channel based at least in part on a timing offset between the selected timing reference point and the scheduled uplink data message satisfying a threshold offset value.

29. The apparatus of claim 28, wherein the instructions are further executable by the processor to cause the apparatus to:
receive, in the first downlink control information message, the indication of the starting point and the length of the uplink data message, wherein selecting the timing reference point comprises selecting the first downlink control information message, and wherein the timing offset comprises a time period between a last transmission time interval boundary of the first downlink control information message and a first transmission time interval boundary of the uplink data message.

30. The apparatus of claim 28, wherein the instructions are further executable by the processor to cause the apparatus to:
receive, in the second downlink control information message, the indication of the starting point and the length of the uplink data message, wherein selecting the timing reference point comprises selecting the second downlink control information message, and wherein the timing offset comprises a time period between a last transmission time interval boundary of the second downlink control information message and a first transmission time interval boundary of the uplink data message.
